(19) United States
(12) Patent Application Publication
(10) Pub. No.: US 2015/0012381 A1
(43) Pub. Date: Jan. 8, 2015

(54) SYSTEMS, METHODS AND COMPUTER READABLE MEDIA FOR ONLINE SHOPPING

(71) Applicant: Sergio Lazaro, Madrid (ES)

(72) Inventor: Sergio Lazaro, Madrid (ES)

(21) Appl. No.: 14/201,460

(22) Filed: Mar. 7, 2014

Related U.S. Application Data
(60) Provisional application No. 61/773,892, filed on Mar. 7, 2013.

(51) Int. Cl. G06Q 30/06

(52) U.S. Cl. CPC G06Q 30/0633
USPC 705/26.8

(57) ABSTRACT

Methods, systems and computer readable media for online shopping are described. The method can include receiving an indication of one or more selected stores and generating a typologies shopping list in response to one or more of received data, historical data and user input. User input can be received via a user interface that includes a multi-layer horizontal scrolling element (e.g., a ribbon) that lets a user navigate through the items offered by a store without using drop down menus. The method can also include receiving product selections and generating an optimized shopping basket based on the selected stores, the typologies shopping list and the product selections.

### RELATED APPLICATIONS

This application claims the benefit of U.S. Provisional Application No. 61/773,892, titled “SYSTEMS, METHODS AND COMPUTER READABLE MEDIA FOR ONLINE SHOPPING”, and filed on Mar. 7, 2013, which is incorporated herein by reference in its entirety.

### TECHNICAL FIELD

Embodiments relate generally to electronic commerce, and more particularly, to methods, systems and computer readable media for online shopping.

### BACKGROUND

Some conventional online shopping user interfaces may be cumbersome or time consuming to operate when purchasing multiple items and/or when making repeat purchases of the same items. Further, some conventional online shopping systems may require that a user select specific products to be placed into a “cart.” These conventional online shopping systems may not provide a way for a user to select a list of product types. Also, some conventional interfaces may not optimize the online shopping selections of a customer. Further, some conventional online shopping interfaces may not provide a readily available visual shopping list building tool. For example, some conventional interfaces may not provide a multi-layer horizontal scrolling interface element that permits a user to navigate the items offered by a store without using drop-down menus.

Moreover, although there have been previous attempts of online shopping list building based on recipes (e.g., Foodonthetable.com), Applicant is not aware of any previous or conventional interface able to provide the kind of shopping functionality described herein, while allowing users to pick brands and products. Existing recipe shopping lists are typically based on products pre-established by the recipes, embodiments solve this problem and can allow users to not only build and shop the recipe shopping list but also to finally pick specific brands and products while optimizing the supermarket selection in order to help achieve maximum value.

Embodiments were conceived in light of the above-mentioned problems and limitations, among other things.

### SUMMARY

Some implementations can include a method of providing an online shopping system and interface designed to help optimize user decision making when purchasing multiple items at a time from one or more vendors. Some implementations can be useful for industries in which the same or similar products are purchased on a recurring basis. Example embodiments are described herein in connection with a grocery shopping example. However, it will be appreciated that similar logic and functions can be applied to online shopping in multiple industries including, but not limited to, building materials, textiles, office supplies, food ingredients and the like. In general, an implementation can be used for any online commerce category having multiple products within a single product type and multiple vendors.

Some implementations can provide advantages such as saving time and/or money, convenient accessibility via desktop or mobile device, access to a wider variety of products (e.g., type, quality and price), a new quality rating system, method of discovering new products, recipe shopping, and/or group shopping. Embodiments for grocery shopping can be implemented for tablets, smartphones and also on the web (e.g., as a web service or web site). Also, some implementations can provide a multi-layer horizontal scrolling interface element (or ribbon) that permits a user to navigate a store without requiring the use of drop-down menus

Embodiments can streamline shopping by breaking the shopping process down into four steps: 1) supermarket preference selection, 2) typologies shopping list building, 3) brand selection, and 4) optimization.

By breaking down the shopping process into the above-mentioned steps, embodiments can allow for a greater level of customization and control over the shopping process than that provided by existing online supermarket shopping systems. By providing a high degree of customization, shopping time can be dramatically reduced. Perfect (or near perfect) market information (for example, the prices of items from the set of stores selected by a user) can help optimize the user's basket value.

Some implementations can include a computerized method. The method can include receiving an indication of one or more selected stores and generating a typologies shopping list in response to one or more of received data, historical data and user input. The method can also include receiving product selections and generating an optimized shopping basket based on the selected stores, the typologies shopping list and the product selections.

The generating an optimized shopping basket can include determining, at the one or more processors, a shopping mode selection, and identifying, at the one or more processors, one or more stores having an activated status. The method can also include translating, at the one or more processors, the typologies shopping list into specific items based on activated typologies and product attribute selections, and presenting, with the one or more processors, the optimized shopping basket for display to a user. The method can further include presenting, with the one or more processors, an expense summary bar. The method can also include providing, with the one or more processors, the shopping mode selection, the product selection, the optimized shopping basket and an expense summary bar for display to a user on a single user interface screen.

Receiving product selections can include causing to be displayed a user interface having a multi-layered horizontal scrolling element configured to provide store navigation without displaying drop-down menus. The method can also include receiving one or more product selections from the multi-layered horizontal scrolling element.

The method can further include displaying ratings for one or more products, each rating being based on actual user pre-selection data, which can represent an objective measure of product quality versus a user-entered rating or comment system. The method can also include providing one or more suggested products based on consumption patterns of one or more of a user associated with the typologies shopping list or one or more users not associated with the typologies shopping list of the user.

Some implementations can include a system comprising a processor coupled to a data storage device having stored therein software instructions that, when executed by the processor, cause the processor to perform operations. The operations can include receiving an indication of one or more selected stores and generating a typologies shopping list in response to one or more of received data, historical data and user input. The operations can also include receiving product selections and generating an optimized shopping basket based on the selected stores, the typologies shopping list and the product selections.

The generating an optimized shopping basket can include determining a shopping mode selection, and identifying one or more stores having an activated status. The operations can also include translating the typologies shopping list into specific items based on activated typologies and product attribute selections, and presenting the optimized shopping basket for display to a user. The operations can further include presenting, with the one or more processors, an expense summary bar.

Receiving product selections can include causing to be displayed a user interface having a multi-layered horizontal scrolling element configured to provide store navigation without displaying drop-down menus, and receiving one or more product selections from the multi-layered horizontal scrolling element.

The operations can further include displaying ratings for one or more products, each rating being based on actual user pre-selection data. The operations can also include providing one or more suggested products based on consumption patterns of one or more of a user associated with the typologies shopping list or one or more users not associated with the typologies shopping list of the user.

Some implementations can include a nontransitory computer readable medium having stored thereon software instructions that, when executed by a processor, cause the processor to perform operations. The operations can include receiving an indication of one or more selected stores and generating a typologies shopping list in response to one or more of received data, historical data and user input. The operations can also include receiving product selections and generating an optimized shopping basket based on the selected stores, the typologies shopping list and the product selections.

The generating an optimized shopping basket can include determining a shopping mode selection, and identifying one or more stores having an activated status. The operations can also include translating the typologies shopping list into specific items based on activated typologies and product attribute selections, and presenting the optimized shopping basket for display to a user. The operations can further include presenting, with the one or more processors, an expense summary bar.

Receiving product selections can include causing to be displayed a user interface having a multi-layered horizontal scrolling element configured to provide store navigation without displaying drop-down menus, and receiving one or more product selections from the multi-layered horizontal scrolling element. Also, generating the typologies shopping list can include generating a typologies shopping list in response to one or more of received data, historical data and user input from a plurality of users. Receiving product selections can include receiving product selections from a plurality of users. The generating can include generating an optimized shopping basket including the product selections of the plurality of users. Receiving product selections can also include causing a typologies-based search interface to be displayed, searching typologies based on one or more user entered search terms, and displaying one or more typology results.

The operations can further include displaying ratings for one or more products, each rating being based on actual user pre-selection data. The operations can also include providing one or more suggested products based on consumption patterns of one or more of a user associated with the typologies shopping list or one or more users not associated with the typologies shopping list of the user.

### BRIEF DESCRIPTION OF THE DRAWINGS

FIG. 1A is a diagram of an example online shopping system log-in screen in accordance with at least one embodiment.

FIG. 1B is a diagram of an example store selection user interface screen in accordance with at least one embodiment.

FIG. 2 is a diagram of an example delivery store selection user interface screen in accordance with at least one embodiment.

FIG. 3 is a diagram of an example smart shopping list user interface screen in accordance with at least one embodiment.

FIGS. 4-10 are diagrams of example visual shopping list user interface screens in accordance with at least one embodiment.

FIG. 11 is a diagram of an example suggested product user interface screen in accordance with at least one embodiment.

FIG. 12 is a diagram of an example volume promotion user interface screen in accordance with at least one embodiment.

FIGS. 13-20 are diagrams of example shopping optimizer user interface screens in accordance with at least one embodiment.

FIG. 21 is a diagram of an example brand user interface screen in accordance with at least one embodiment.

FIG. 22 is a diagram of an example product information user interface screen in accordance with at least one embodiment.

FIG. 23 is a diagram of an online shopping system environment in accordance with at least one embodiment.

FIG. 24 is a flow chart of an example online shopping method in accordance with at least one embodiment.

FIG. 25 is a diagram of a computer system configured for online shopping in accordance with at least one embodiment.

FIG. 26 is a diagram showing example online shopping data in accordance with at least one embodiment.

FIG. 27 is a flow chart showing details of generating a smart shopping list in accordance with at least one embodiment.

FIG. 28 is a flow chart showing details of optimizing a shopping basket in accordance with at least one embodiment.

### DETAILED DESCRIPTION

In general, some implementations of a shopping system as described herein can include a catalogue of every product in the supermarket according to the following structure:

Aisle, which can be the broadest group to which any product may belong. For example, “Reduced Fat Milk” belongs to the aisle “Dairy, Cheese & Eggs”.

Category, which is the second broadest group to which any product can belong to. For example, “Reduced Fat Milk” belongs to the category “Milk”, other categories in the same aisle would be “Yogurt” or “Cheese”, which describe broadly what a product is.

Subcategory, which is essentially the name that defines any product if you remove the brand. For example, if a user were to ask himself/herself regarding any product in the supermarket “what is this?” and the brand could not be used to define the item, the answer could be the subcategory. Some online supermarkets show products within subcategories and do not go deeper classifying products. Users then have to find and compare the products they are looking for within those subcategories which might include thousands of products. This can place a significant burden on the consumer.

Typology, as discussed herein, an embodiment can include typologies, which is basically a combination of “subcategory+key attribute+size”. Every item in the supermarket can be classified according to these three variables, which allow people to create an entity (typology) that aggregates all products matching their three chosen variables. For example: “Reduced Fat”+“Milk”+“Medium 1 L” would be a typology, which might include 30 products in a database.

Some implementations permit users to create lists of typologies as opposed to lists of final products which are what most online supermarkets do today.

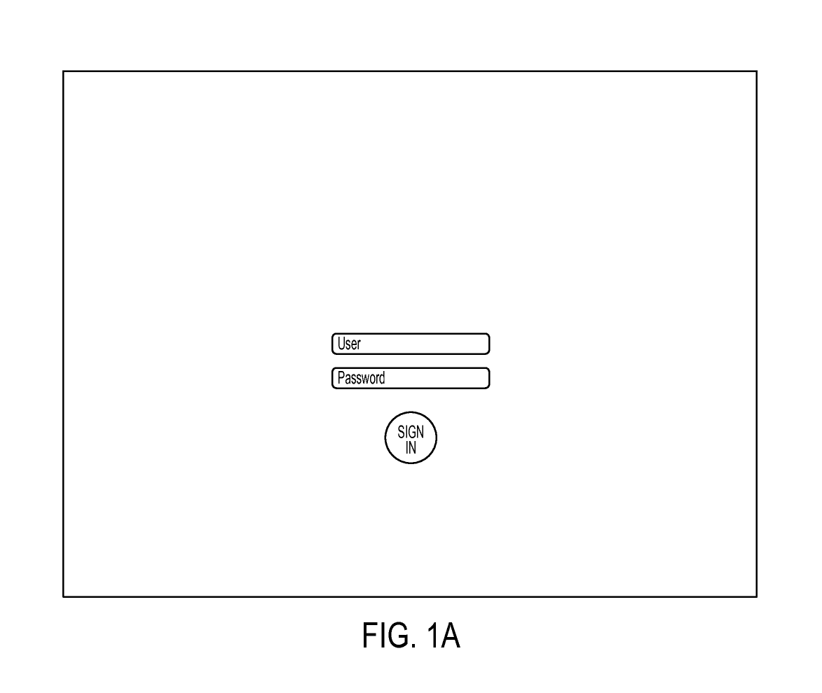

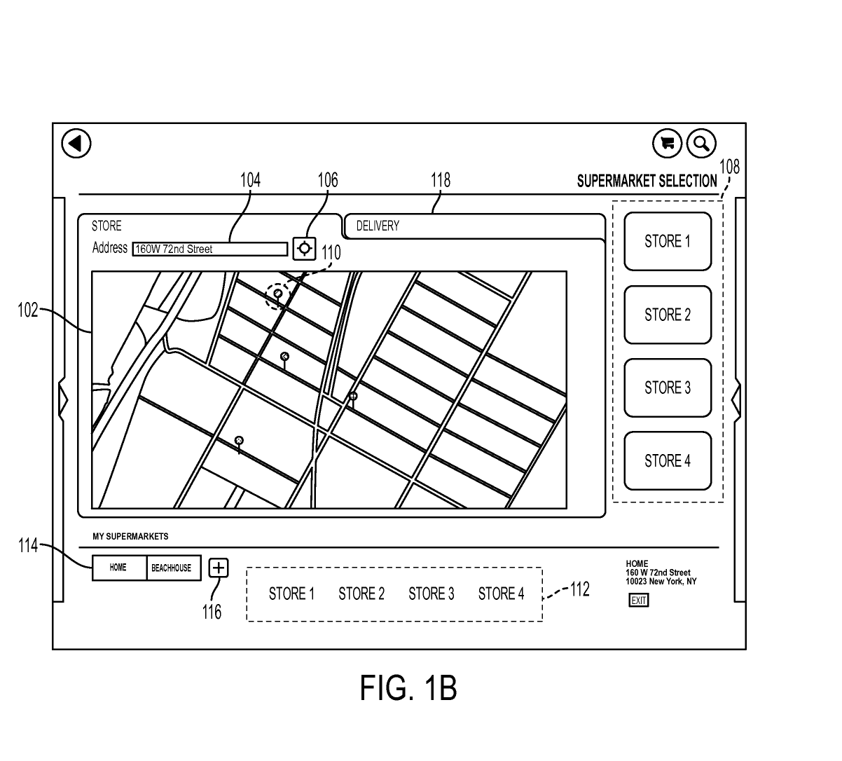

Using the interface shown in FIG. 1A, a user can log in to the online shopping system. Prior to logging in, a user may be required to create an account within the system to be able to use it. Creating an account can involve registering contact and payment details as well as selecting an address for grocery delivery. Users can invite others (family or flat-mates) to their account as shopping list builders. For example, family members often have different shopping preferences or need different products, as a result they have to remind the member in charge of doing grocery shopping to buy the desired items or to shop them by themselves, the system can allow a primary users to add others as secondary users to the account so that secondary users can build the shopping list they need and submit it for approval to the primary user. Also, multiple users who select to self-shop may shop collaboratively in the supermarket via a synchronized list (e.g., a shopping list system provided/stored on a cloud computing system).

### Shopping Step 1: Supermarket Preference

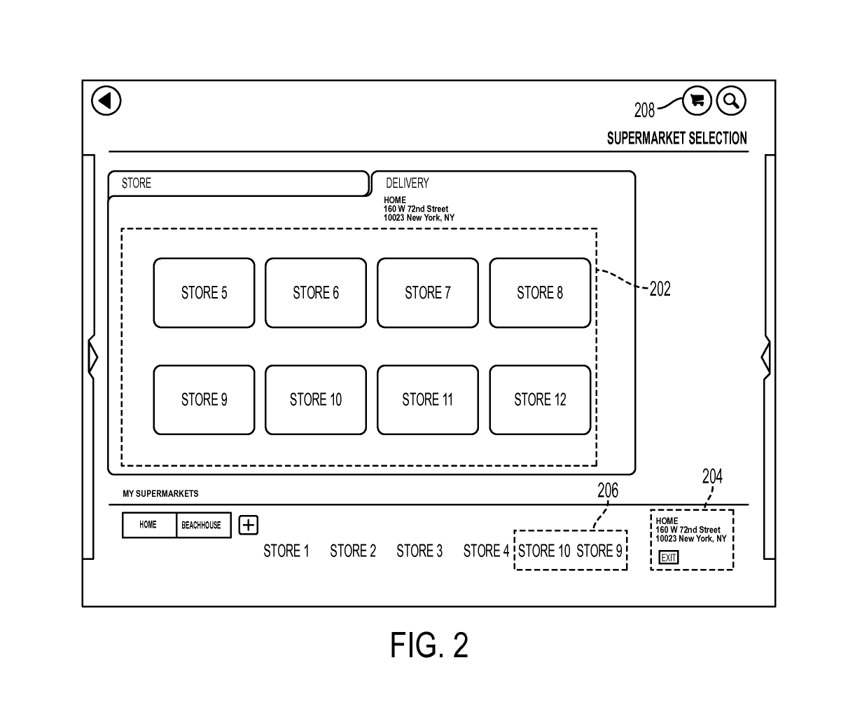

Once an account within the system is created, the user may first select the supermarket(s) he/she would consider buying from. The process is split between selecting brick & mortar stores (the ones he/she would physically go to, for either picking the items (traditional self-shopping way) or to collect an already assembled basket) which is illustrated by FIG. 1B and selecting supermarkets for home delivery, illustrated by FIG. 2.

FIG. 1B: Brick & Mortar Store Selection

In this screen the user can select physical stores to add to his/her supermarkets preference, to do so he/she may first locate the store by focusing the map 102 on the city area where the store is. This can be done by either zooming with the fingers into the map (powered by Google), or alternatively by typing the store's or a nearby address in the Address box 104 and subsequently tapping the target button 106. Once the map is on the right city area the scroll on the right 108 shows the supermarket banners that are present in the area. The user can activate or deactivate the banners to look for the stores he/she is interested on. Once a banner is activated (lighted-up in yellow) the map will signal through pins 110 the location of the stores belonging to that banner. Every banner can have different pin colors to easily differentiate between them. Once the user has located the store, he/she can add the store to his/her preference by simply taping on the pin and selecting the add button in a subsequent pop-up menu. Once a store has been added, the banner from that store will show up in the users' supermarket preference 112. Details of the store will be available by simply tapping into the banner logo located in the supermarket preference, irrespectively of what the map is showing. At any point users can modify (taping on the store logo they want to remove and then on the remove button) or eliminate their existing supermarket preference (by removing all the logos within it), but they can also create new supermarket preferences. In the example the existing supermarket preference is called “Home” and the lighting of the “Home” button 114 signals that it is that supermarket preference the one that is being displayed. To add a new supermarket preference the user would simply tap in the “+” button 116 and a pop-up menu would show up to create and configure the new preference. In the example the user has two supermarket preferences “Home” and “Beach House” this feature allows the user to buy through the system wherever he/she is without wasting time creating new supermarket lists.

Once the user has selected the physical stores that he/she wants to buy from, he/she will be able to add supermarkets for home delivery (they can or cannot have physical stores) by tapping on the “Delivery” tab 118.

In the screen shown in FIG. 2, a user can see the banner logos 202 from supermarkets capable of delivering to his/her selected delivery address 204. The user can activate or deactivate the banner logo to add or remove the supermarket to his/her supermarket preference. In the example shown in FIG. 2, the logos from Freshdirect and Peapod have been activated and are shown in the supermarket preference 206.

If a store capable of delivering to the user's address has already been selected in the brick & mortar store selection screen, FIG. 1B the banner logo can be shown as activated in the delivery screen.

Once the user finishes setting up his/her supermarket preference, the user can start shopping. To do that he/she can tap on the cart button 208 located in the upper right side corner of the screen.

Next, at step 2, the user can build a shopping list (e.g. a predictive typologies shopping list based on typology, not specific item). Unlike some current shopping methodologies in which shopping lists may be built adding final products directly to them, an embodiment can be based on building a shopping list out of product typologies (for example, instead of adding a bottle of “Tropicana Orange juice—No Pulp (59 oz)”, the user may add the typology and the size of the product that he/she is searching for and leave the final product search to the system. For example, “One” bottle of “Refrigerated Orange Juice” of “Medium (59 oz)” size. Typologies, sizes (which may at times be established using ranges) and other classifications may be determined by the system maximizing utility for the user and, depending on the product, might vary significantly (i.e., what it is considered a medium size in soft drinks may be significantly different than what it is considered medium in spiced sauces).

In addition, unlike some other shopping lists which are meant to be static (i.e., only the user can modify them), embodiments can include a smart shopping list designed to be dynamic, e.g. the list changes and adapts to the user's behavior, and can suggest different products each time. These suggestions can be based on what the smart list algorithm generates as the most probable shopping list according to each user's consumption patterns.

Smart List generation can include two main approaches, one for a first time user and one for a returning user. For a first time user, the list can be generated manually by the user (directly adding each element) or automatically by the system (either based on the users' past consumption data extracted from retailers' loyalty card systems or based on the average consumption data from similar customers according to age, location, number of people in the family, pet ownership and the like). For a returning user, in addition to the components of a first time user smart shopping list, the returning user smart shopping list can be automatically generated based on the user's past consumptions within the system. The more the user shops through the system the larger the weight of this last component can be during the smart shopping list generation.

When the list is generated automatically, the system can use an algorithm to predict the elements of the list. The algorithm analyzes consumption data for a given user establishing consumption cycles for one unit of each product typology (note the shopping list consists of product typologies not specific products). Based on those cycles, the algorithm can determine the probability of that typology being shopped at that time. This calculation can take into account other variables including the estimated amount on inventory (based on previous purchases and/or shopping lists), average expiration dates in the typology and time passed from last consumption. The system can then filter each typology and classify it according to the probability of being shopped: highly likely, likely or uncertain. Typologies belonging to the highly likely tier will have a very high probability of being shopped (e.g., greater than about 85%) and will be shown activated in the list, those belonging to the likely tier will have a high probability of being shopped (e.g., between about 70% and about 85%) and will be shown shaded and those belonging to the uncertain tier will have a lower probability of being shopped (e.g., <about 70%) and may be hidden. The system can also pre-populate units and formats automatically based on the average amount and format shopped by that user.

Once the system has generated the automatic list, the system can create product virtualizations to represent items on the list. Items will be selected for product virtualizations based on relevance to the user, e.g. if the typology is Reduced Fat Milk and the user has selected only products with the attributes “Omega 3” that virtualization will only use brands that produce this type of Reduced Fat Milk to generate the product virtualization.

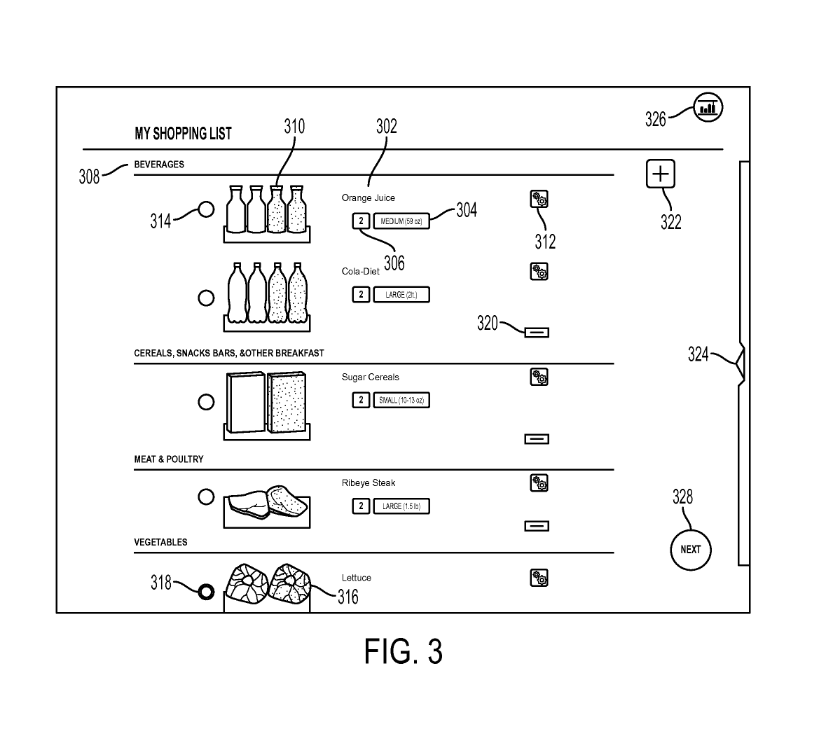

FIG. 3 shows a scrollable shopping list in which, as mentioned above, items are added based on typology 302, size 304 and amount of units 306 the user would like to buy. Items are classified within a system aisle 308, and typologies are illustrated with product virtualizations 310 that might include branded iconic products to help users recognize the typology they represent. Users will be able to modify their preferences regarding specific product attributes by tapping into the gears button 312.

The system shopping list includes three kinds of products, out of which two are directly visible while the last kind may only be revealed under user request.

Visible Products include those that are determined to be highly likely and likely to be added to a user's shopping list. Highly likely products include those products that, according to the system's algorithm have a very high probability of being added to the user's shopping list at that time. Highly likely products are clearly illustrated (not shaded) and their activation button 314 will automatically be lighted up. Likely products are those that, according to the system algorithm, are likely to be added to the user's shopping list at that time, although the probability is lower than that of “highly likely” products Likely products will come up shaded 316 and their activation button will be off 318. Additionally they will not show the “units” or “size” buttons to avoid user's confusion. To activate these products for the shopping list the user will only have to tap into the activation button.

Hidden products are those products for which based on the user's consumption patterns, the system algorithm cannot conclude whether the user will be adding the product to his/her list or not. However, these products have been shopped at least once to be able to show up in the system shopping list. While hidden products are hidden in the system aisle they belong to, users can reveal them by tapping and dragging down the expanding button 320 located to the right of every aisle section in the list. Once the product has been revealed, the user can easily activate it for the shopping list by tapping into the activation button.

Using this shopping list structure and prediction methodology, the system can seek to achieve a significant reduction of the time the user invests on building a shopping list. If the user wants to add a new product to the list (e.g., a product that has never been purchased before), he/she can quickly add it to the list by tapping into the “+” button 322 (located in the top right corner of the list) and searching for the item typology in the search menu that will pop up. For example, some implementations can include a typologies based search engine that can provide an improved and faster way of finding products, as opposed to the current supermarket search engines which may be only based on text search of product names. Typology based search is a text search on typology name, which provides a richer set of data and can permit users to get to what they want faster. For example, if a user were to type “cheese” in any supermarket search engine it may show all products whose name includes the word “cheese” and the result could consist of hundreds of products. For example, the results could include “bleu cheese” and “4 Cheese Pizza”, however they are fundamentally different products. In an implementation with a typology based search if a user types “cheese”, the system will be able to understand the conflict and provide an assisted search by asking you if you are looking for the cheeses on the “Dairy, Cheese and Eggs” aisle or the on “Frozen Food” aisle. A similar process can occur if the conflict takes place at the category, subcategory or typology level (e.g. after typing butter a user may get the options “salted” and “unsalted”). Once the user defines the typology he/she can also add additional attributes narrowing results and possibly reducing the final product search from minutes to seconds.

In some embodiments, this list can be shown as a list of recipes the user plans to cook. A process similar to that discussed above (likelihood of that user adding recipes to the shopping list) can be followed, with the products grouped into recipes. These recipes can be sourced externally, from within the system or be created by the user. The user will also be able to share his/her own recipes with friends or even publish them within the site for use by other users.

On the right side of some (or most) screens throughout the system there can be a hidden tab 324 that can be revealed by dragging the small arrow to the left. This tab will show options within the site.

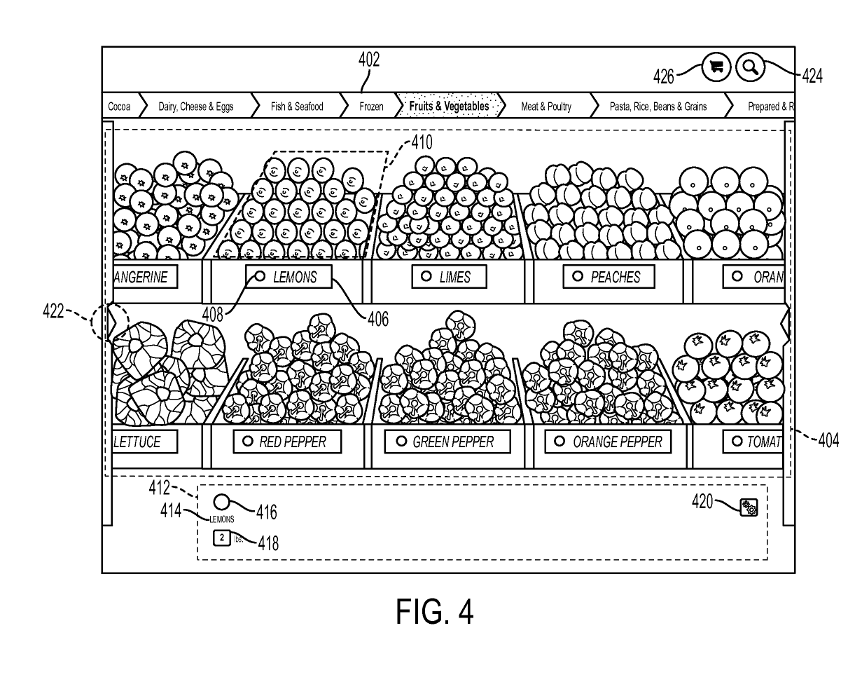

In some embodiments, this list can be shown visually through a supermarket-like experience. In an example embodiment illustrated by FIGS. 4, 5, 6, 8, 9 and 10, users can access this shopping list mode by tapping on the visual shopping list button 326.

A visual shopping list mode can be used when a user desires to explore the store to form an idea of what to buy. FIG. 4 shows a visual shopping list mode, in which the user can navigate through an entire supermarket simply sliding the central image 404 while, at the same time, reviewing and modifying the items in the shopping list.

The visual shopping list mode can include navigation wheels 402, which are explained in detail below. Navigation wheels 402 can permit the user to quickly access an aisle or category he/she is looking for. The lighted up section indicates the aisle that is being explored.

The visual shopping list mode can also include a central image 404 that shows the aisle content at a subcategory level (or category level if there is no subcategory, e.g. “Fruits & Vegetables”). What defines a category or a subcategory level can be determined in each case by the system attempting to maximize user's utility. The visual shopping list mode can also include labels 406 that indicate the subcategory illustrated above them. They include an activation signal 408, which shows whether a product within that subcategory has been added to the shopping list or not. Labels become yellow when the user taps in the subcategory illustration 410 to reveal the product selection area 412.

The product selection area 412 shows the product typologies 414 that have been activated for shopping and thus added to the user's shopping list. The product selection area 412 also shows other product typologies that are deactivated but have been previously shopped by the user. Typologies can be activated/deactivated by tapping on the activation button 416 and added, modified or removed by tapping on the gears button 420. The Units button 418 indicates the units of that product typology added to the user's shopping list.

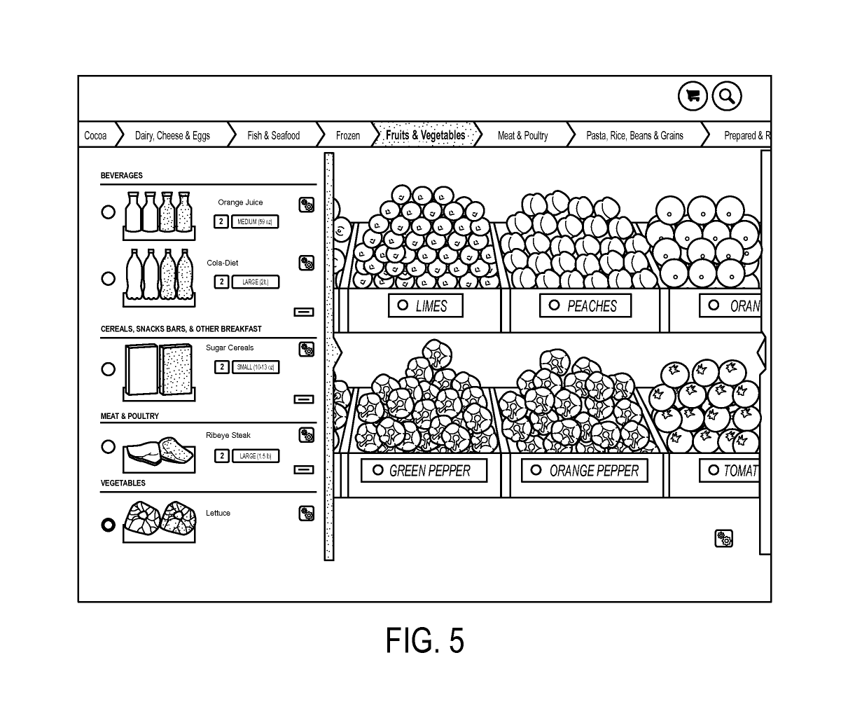

A smart shopping list tab 422 permits a user to review the content of the shopping list by dragging the yellow arrow located in the left tab, which will show a reduced version of the smart shopping list shown in FIG. 3 and as illustrated in FIG. 5.

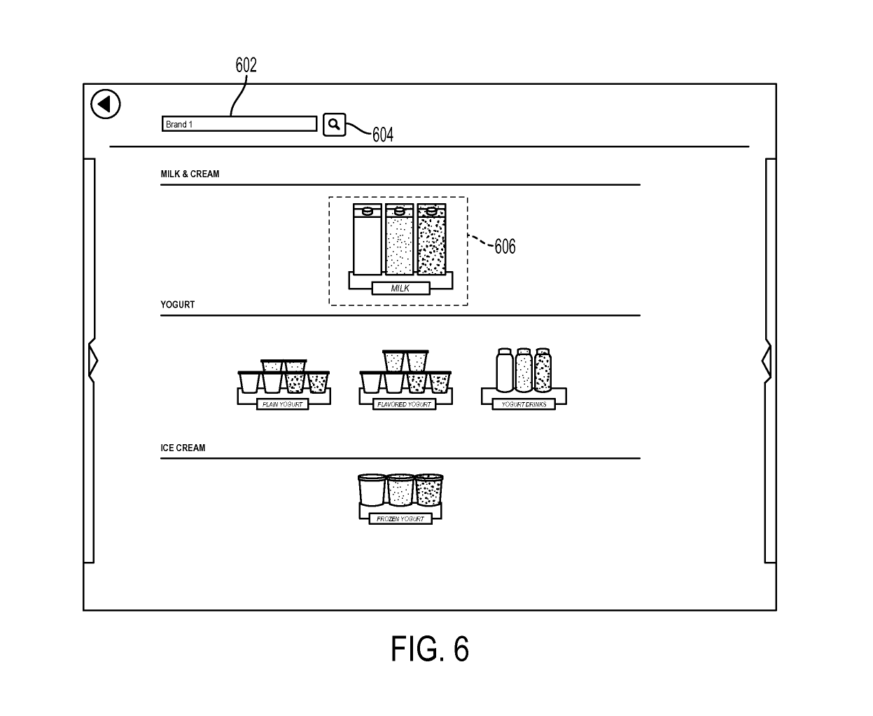

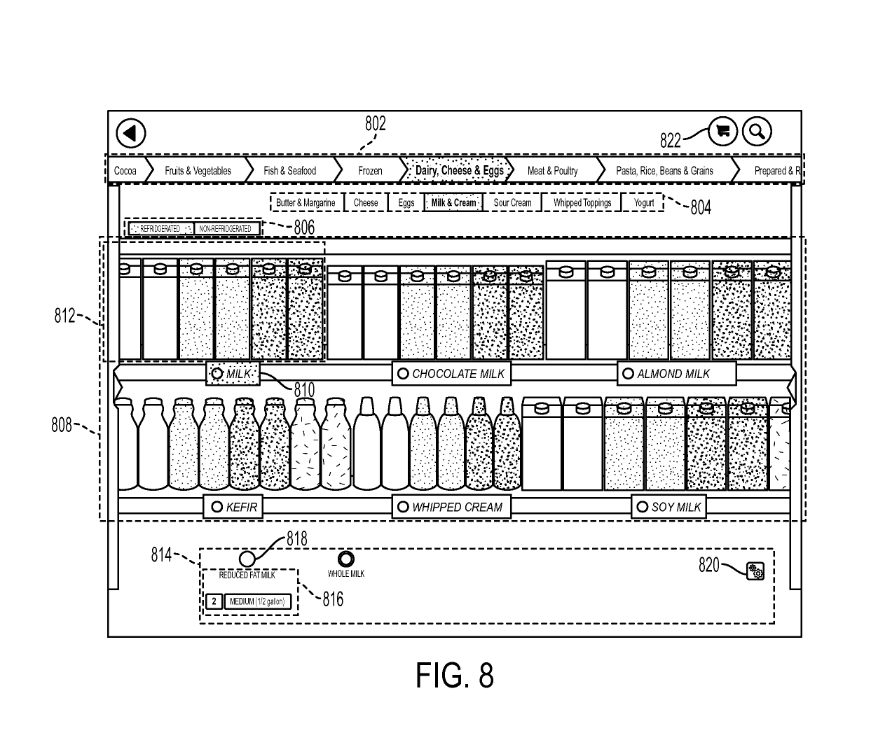

The search button 424 permits the user to quickly search for specific product categories using the system search methodology, this methodology is illustrated in FIG. 6. Unlike common online supermarkets search methodologies, the system does not show final products, instead it funnels the user's query to the category he/she is looking for. For example if the user types “Milk” in the text box 602 and taps the “go search” button 604, the system will visually show all categories (not products) containing a relevant milk product, for example on top of showing the “Milk&Cream” category, it would show others like “Condensed Milk” which belongs to the “Baking Ingredients” aisle instead of the “Dairy” one. This method will visually help the user find what he/she is looking for right away. In the example illustrated on FIG. 6 another possibility of search is shown, in this case the user has typed a brand in the text box 602 instead of a product type. Sometimes users clearly know the brand of the product they search for, but not the typology. The system can show categories in which that brand is present. For example, Stonyfield produces Yogurts and Ice cream in addition to Milk. Since the user in our example is only interested in “Milk”, he/she would only have to tap on the milk icon 606 to get to FIG. 8 where the subcategory is located. This method also contrasts with current search methodologies of online supermarkets, in which after typing a brand name mixed products from different categories of that brand (and sometimes other brands) show up and no differentiation or cataloguing is done between subcategories and typologies.

The shopping cart button 426 can be used to take the user back to the interface screen of FIG. 3 to start the final shopping process.

Horizontal Navigation System:

One of the system's key features is the ability to explore the entire online supermarket without going in or out of menus, similar to walking around the physical supermarket. In the physical store, people count on their sense of orientation. They can easily identify where they are and how to get to the aisle they are looking for by just drawing the shortest path to that aisle in their minds as long as they know the store.

When shopping on a screen, the sense of orientation is of limited use and signaling where the user is and how to get to the aisle he/she is looking for is of vital importance. However, no supermarket known to Applicant has managed to find the way to provide a fluent supermarket navigation (like the one at a real store, without going in or out of menus) while signaling where the user is and what is left for him to see in the market. The horizontal navigation system described herein solves this problem.

The system horizontal navigation depends on 4 elements: an aisle navigation wheel 802, a category navigation wheel 804, auxiliary buttons 806 and labels 810.

The aisle navigation wheel 802 can be present throughout the visual shopping list mode. The aisle navigation wheel 802 can contain the main supermarket aisles, and can be navigated sliding the wheel left or right as desired. The wheel moves independently from the rest of the screen. When the user finds the aisle he is interested on he can tap on that aisle section of the wheel and the section will light up showing the categories that aisle includes 808.

Some supermarket products have more varieties than others, when products have many varieties the industry has created subcategories to differentiate between them. For example: Milk & Cream is a category but within it there are many varieties and thus the industry has created subcategories like “Milk” (the traditional product), “Soy Milk” or “Almond Milk” these are milks as well but quite different from the traditional product. When an aisle contains categories without subcategories (e.g. “Fruits & Vegetables” aisle) the category navigation wheel 804 may not be shown as it is the case in FIG. 4. However, if the aisle contains categories that include subcategories, then the Category Navigation Wheel 804 will appear underneath the Aisle Navigation Wheel 802. The category navigation wheel 804 contains the categories included within that aisle and allows the user to quickly navigate through the categories by simply spinning the wheel left or right as desired. For example in FIG. 8 some of the categories within the “Dairy, Cheese & Eggs” aisle like “Cheese”, “Milk & Cream” or “Yogurt” contain many subcategories, as a result the Category Navigation Wheel 804 is shown. In the example our user is looking at the “Milk & Cream” category in the wheel and in the central image 808 he/she can see all subcategories it includes: Milk, Chocolate Milk, Almond Milk, Kefir, Whipped Cream and Soy Milk. If the user slides the central image to the right it will move on to the next category which in this case is “Sour Cream” in the Category Navigation Wheel and the “Sour Cream” section of the wheel will light up. Once the Category Navigation Wheel reaches the end of the aisle it will continue in the following aisle, in our example “Meat & Poultry”. Thus, a user may be able to “walk” fluently through the supermarket simply sliding the screen from right to left. This navigation system also allows the user to know at every point where he is and what is left for him to see in the market while providing a supermarket-like navigation experience.

Auxiliary buttons 806 will be available in some situations, the auxiliary buttons 806 can permit the user to navigate a category containing subcategories which follow a specific cross-classification. For example in FIG. 8, the example shows the “Milk & Cream” category in the Category Navigation Wheel, and the Auxiliary buttons show a different classification that affects all subcategories within “Milk & Cream”, in this case Refrigerated/Non-Refrigerated products. In the example “Refrigerated” button is lighted up which means that the user is in that specific subsection inside the “Milk & Cream” category, if the user was interested in “Non-refrigerated” products he would just have to tap in the “Non-refrigerated” button and the central image would fast forward to that subsection of the aisle. The auxiliary button 806 provides a different kind of classification across subcategories. In another example, in the Shampoos category, there are several subcategories of shampoos, but there is another cross-classification that affects them, the gender classification. The auxiliary button 806 would in this case show two options “For Men” and “For Women” and people will be able to reach the subcategories that belong to them by using the auxiliary buttons

Labels 810 can be used to indicate the subcategories within a category. If the category does not have subcategories they will show the category itself

The four elements mentioned above can provide for a fluent navigation throughout the online supermarket. An important note here is that the system may not be showing final products in its Visual Shopping List Mode either, only categories, subcategories, typologies and attributes (the last two will be explained below). The user will not be “buying” as we know it in this part of the system just building a list to be optimized later on.

### Shopping List Building in the Visual Shopping List Mode:

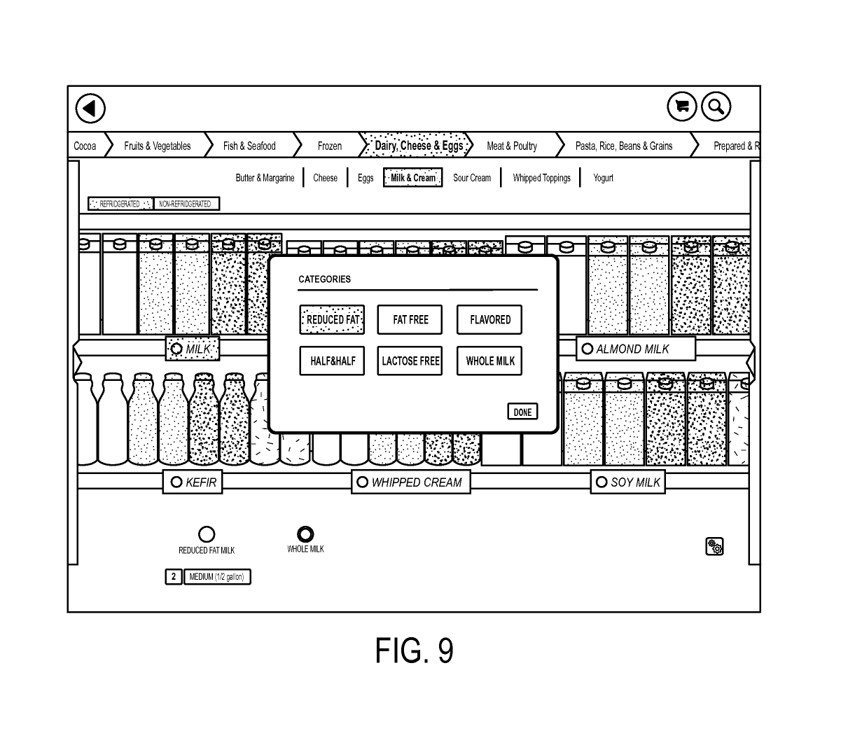

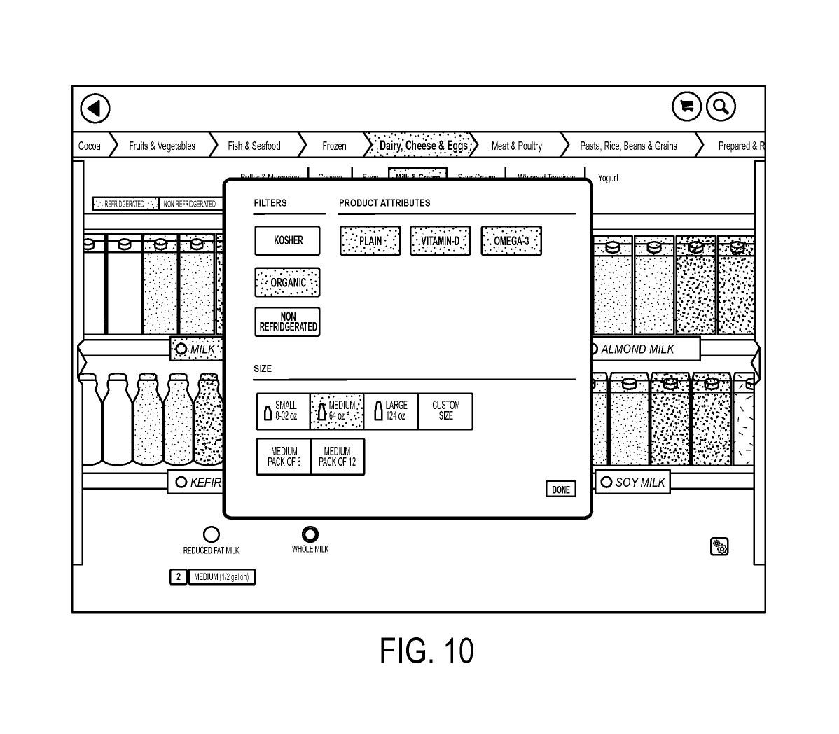

As explained above, in the system, users will be able to navigate the entire supermarket by simply sliding the screen left or right as desired. To add an item (typology) (“Milk” for example) to the shopping list, users will only have to tap on the subcategory illustration 812, which will activate the product selection area 814. If the user does not have any typology preference established for that subcategory FIG. 9 will directly pop up, asking the user about the product typology he/she would like to buy, in the example our user tapped “Reduced Fat”, then the system will ask for specific product characteristics and size in FIG. 10. Once the user finishes introducing his/her product preferences, the system will take him back to [FIG. 8] where his/her preference and size for the product typology “Reduced Fat Milk” 816, were added in the product selection area 814. By tapping in the activation button 818 the user will be able to activate/deactivate that typology for his/her shopping list. In our example our user has activated “Reduced Fat Milk” but deactivated his “Whole Milk” preference since he/she does not want to buy it this time. Users will be able to add/remove or modify their typology preferences by tapping on the gears button at any time 820.

This shopping list building methodology can permit the user to go through the entire supermarket adding preferences for the product he/she likes and activating/deactivating them for his/her shopping list.

Once the user finishes building his/her shopping list, he/she can tap on the “Shopping cart” button 822 to go back to a screen similar to that shown in FIG. 3 where after reviewing everything included is correct the “Next” button 328 will take them to the last steps before shopping optimization.

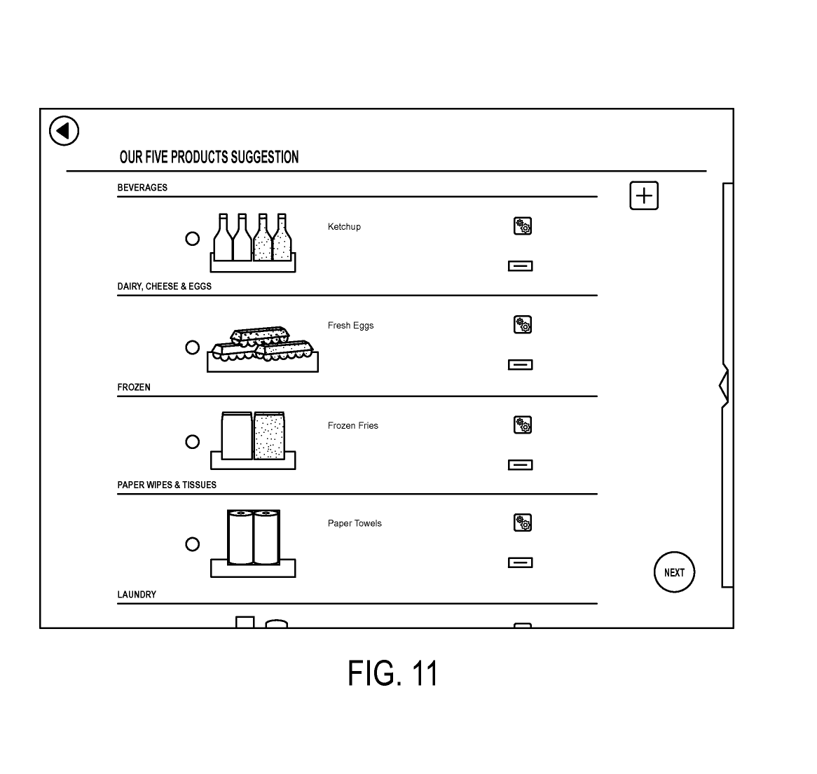

FIG. 11 shows a basket completion phase in which, after tapping the “Next” button in (e.g., as shown in FIG. 3) a list of products can be suggested to users, this list will aim to complete the user's own shopping list by showing one or more of the following:

Items that have a high shopping correlation with those already in the user's list. However, unlike the suggestions made in FIG. 3, these suggestions may not be based on the user's own consumption patterns, they may instead be based on other users' consumption patterns who share similar consumption behaviors

The basket completion screen can also show items that have not been shopped by the user in a very long time and that are relevant to the shopping list. Also, the basket completion screen can show items that although according to the system algorithm the user is not going to need at this time, might make sense to buy because of an extremely good discount available. These items can be flagged as “deeply discounted” so that the user understands why the item is being suggested. This feature will allow the user to optimize shopping decisions according to the equation variable “Time”. For example: if there is a great discount in one of the products the user will be buying next week, the system will suggest to buy the item this week instead to take advantage of that discount.

The basket completion page mechanics work similar to those of FIG. 3 discussed above.

Once the user is ready to move on tapping on the “Next” button can take him/her to the last part of the Shopping list building phase.

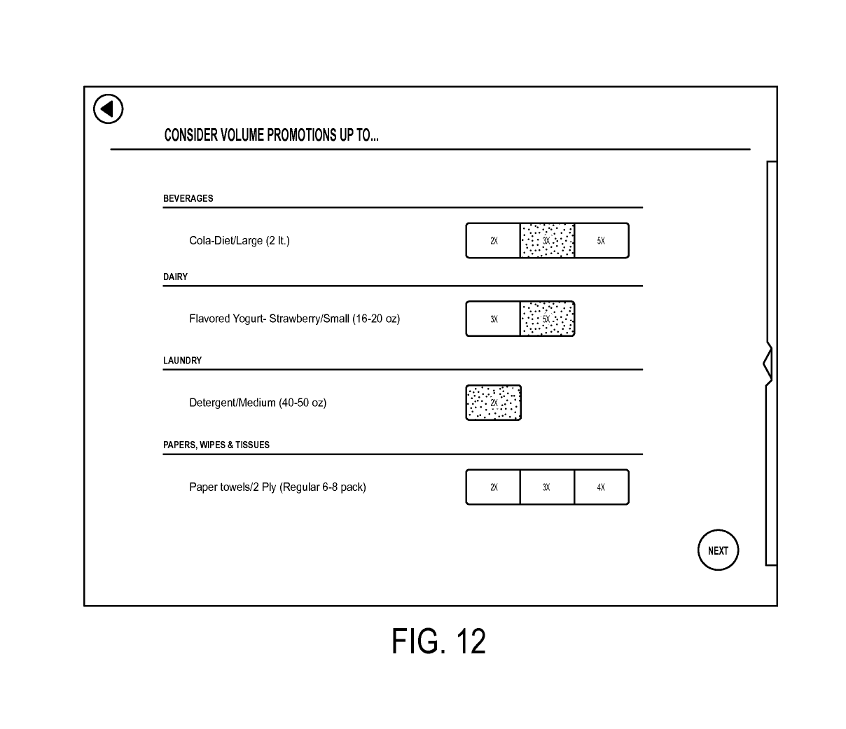

FIG. 12 shows a Volume Promotions screen. Once the Shopping List is built, the system can analyze all product typologies the user is looking for in every supermarket (amongst the one he/she considered for shopping) to find whether there are any volume promotions (e.g. “3×2” or “buy X number for a reduced price”) and will show in FIG. 12 the volume promotions available (if any). In the example four products have this kind of volume promotions in the market, the user can choose whether to consider volume promotions or not. In this case for example he/she is considering buying up to 3 units of “Cola-Diet/Large (2L)” for a reduced price. Users may be given another chance of activating/deactivating volume promotion in the following shopping phase.

Finally once the user is ready he/she may go on to the brand selection phase of the system shopping methodology by tapping on the “Next” button.

### Step 3: Brand Selection Phase

In the present shopping methodology, the last two shopping steps: “Brand Selection” and “Optimization” are both done by a shopping optimizer in the system. The shopping optimizer is a feature that allows shoppers to find the maximum value for money (e.g., it can help them find the cheapest combination of items and which supermarket(s) offer that combination) in the minimum shopping time (e.g., it can reduce common shopping time to 5-10 minutes, versus the current 30 minutes if the user shops online or 45 min if the user goes to a brick and mortar store).

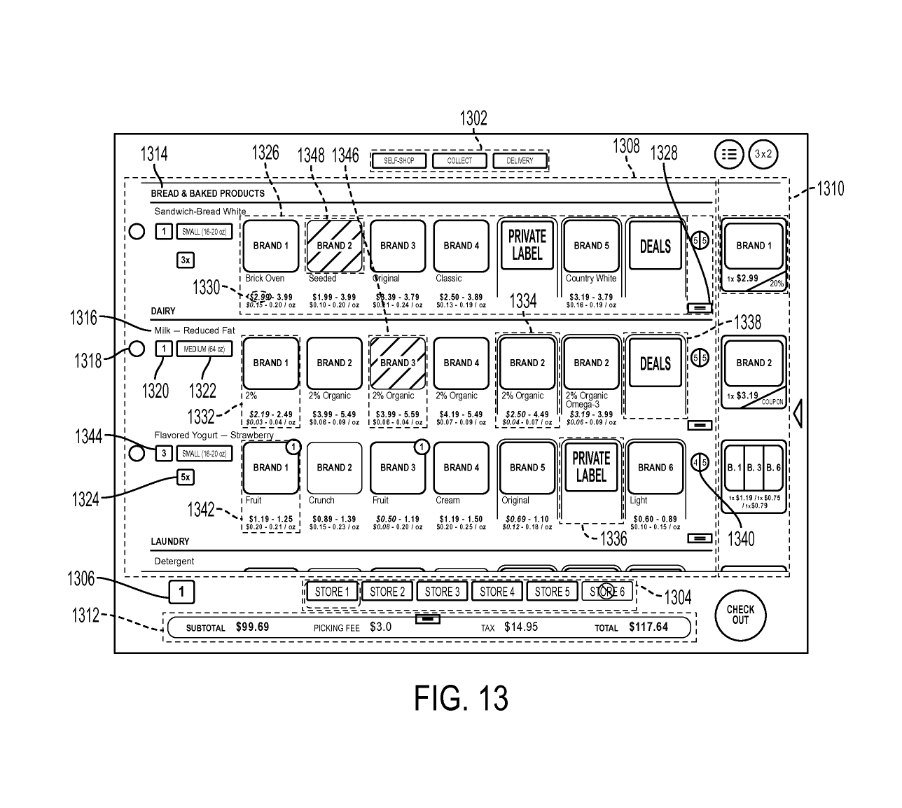

FIGS. 13-20 show diagrams of the optimizer.

The Optimizer has five key sections as discussed below:

Section 1: Shopping Mode 1302.

This section includes three buttons corresponding to the three fulfillment options available when shopping at a supermarket: “Self-shop”, “Collect” and “Delivery”

Activating or deactivating the shopping mode buttons allows the shopper to find out what is the best fulfillment option for him/her among the ones he/she is willing to consider.

Fulfillment option 1—Self-Shop: when this mode is activated, the system adds to its comparison system the possibility of the shopper going to the supermarket to pick the optimized basket himself. This is normally the cheapest option since it saves picking or delivery fees, however it implies a significant amount of time for the shopper, since he/she will have to find the specific items in the store himself.

Fulfillment option 2—Collect: when this mode is activated, the system adds to its comparison system the possibility of the shopper going to the supermarket to collect a basket of products already picked by the supermarket staff

Fulfillment option 3—Delivery: when this mode is activated, the system adds to its comparison system the possibility of the supermarket assembling the user's shopping basket and delivering it to the user's designated address

Section 2: Supermarket Selection Bar 1304

In this section the user will see buttons with banner logos belonging to the pool of supermarkets he/she selected during “Step 1: Supermarket Preference”. Buttons can be in three types of status activated, deactivated or disabled, as described below.

Activated status can indicate that the user is willing to buy from that supermarket if his/her optimal basket is sold by them. Deactivated status can indicate that at least at this point the user does not want buy from that supermarket and is not including it for shopping optimization. Disabled status can indicate that given the user's product preferences that supermarket cannot provide a basket with the shopping list products (e.g., in the illustrated example Peapod would be a disabled supermarket 1420). This situation will be discussed below in connection with “Step 4: Shopping optimization and user confirmation”.

Buttons in the selection bar can have different colors or shapes indicating whether the supermarket is a pure online, a store-only or a hybrid supermarket.

The supermarket selection bar can work in combination with the “Purchase from” button 1306, which indicates how many transactions is the user willing to do, e.g. if the button number is “1”, the system will optimize the user's shopping basket based on just one transaction (i.e., the system will find which is the supermarket that given the user's product preferences maximizes user's value for money). If the “Purchase from” button is a “2”, the system will split the basket in two groups and find out the two supermarkets that combined maximize value for money. If the result of the combination is worse a single transaction from just one supermarket it will alert the user and provide the single supermarket that maximizes value for money.

Section 3: Products Menu 1308

The products menu is the heart of the system, it translates the already assembled user shopping list into specific products. These products are fed to the user according to the typology and preferences established during the shopping list building phase. The Products Menu follows the same structure as the Smart Shopping List discussed on FIG. 3, it is divided according to supermarket aisles 1314 an inside every aisle each row represents a different product typology 1316 that was added during the shopping list building phase.

Every row in the products menu contains the following elements:

Activation Button 1318, which can be the same button used throughout the system to activate or deactivate product typologies. In the products menu, all products typologies are activated. If the user decides to deactivate a typology the corresponding row will be deleted, to add it back the user would have to go back to the Smart Shopping List as shown in FIG. 3.

Units Button 1320 can indicate how many units of that product the user wants to buy. At this point most users will not have to think about that question since they already factored in quantities during the shopping list building phase, but the button is also present here in case users want to make a last minute change

The Format Button 1322 can indicate the desired size/format of the product. Again size classifications are tailored to each specific product typology. The system will classify them maximizing users' utility. As it is the case with the Units button, most users will not make any format modifications at this point in their shopping process unless they want to find out price variations based on size

The Volume Promotions button 1324 can permit the user to change his/her preference for volume promotions. This preference is established as shown in FIG. 12 but this button also allows the user to make last minute changes.

Product Icons 1326 in the Products Menu each row contains 7 product icons. Each icon represents a specific market product (or set of products in the case of special icons) illustrated with the brand logo from the actual product package. Underneath each icon, the system can include one or more items of the following information (except for special icons): one or two descriptive lines listing the key product attributes, product weight, product rating, unit price range and/or unit price/weight range.

Product weight and rating will usually be hidden in the shopping optimizer, to reveal them, users will have to drag down the expanding button 1328 located to the right of one or more rows.

Price and price/weight ranges represent the smallest and highest price for that product within the pool of supermarkets the user has activated in the supermarket selection bar 1304. When the smallest price in the range is the result of some sort of supermarket promotion, coupon or special discount it will be shown in red 1330, to indicate users the item's price is a discounted one.

In the products menu there are several kinds of icons, such as common icons 1332. Common Icons 1332 can represent a specific market product. They can be differentiated from the other types of icons because they have no colored background. For example, in every row there can be a maximum of 5 common icons, 4 if one of them is traded for the “Deals” special icon.

There can be two types of common icons:

1) Suggested: These icons are fed directly to the user by the system. They are selected based on the product preferences established by the user during the shopping list building phase and presented to him/her based on relevance criteria. If the user does not like the suggestion or simply wants to change it, this can be done easily: tapping once into a suggested icon will trigger the popup of two side arrows, by tapping on these arrows the user will be able to change the product suggested

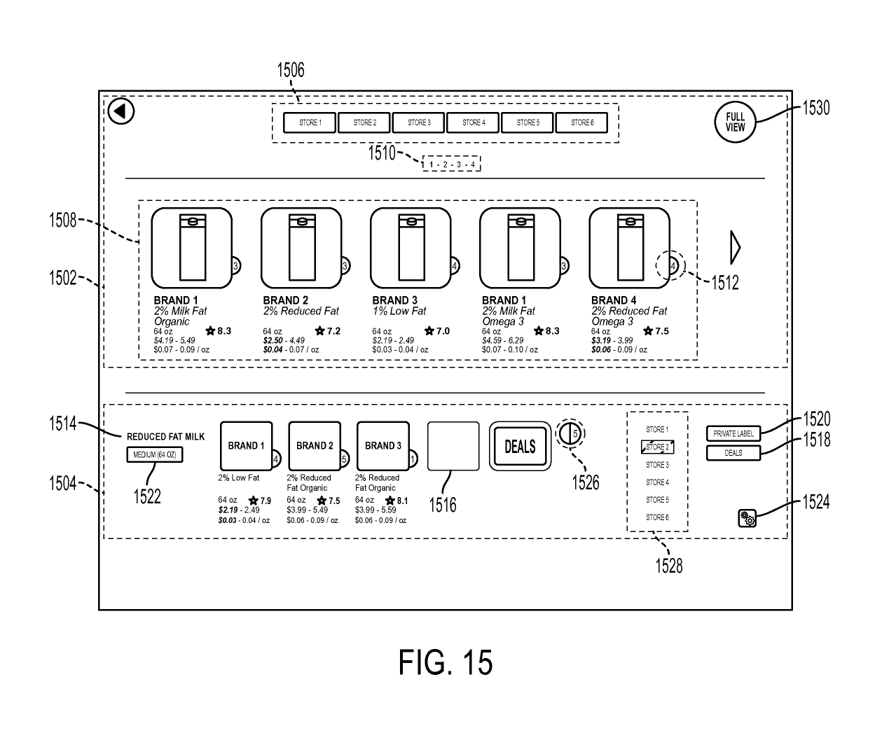

2) Pre-selected: These icons are specifically selected by the user. To do so the user may open the “Product Pre-selection Menu” FIG. 15 by double tapping in any of the common icons.

There is no physical difference between suggested or preselected common icons.

FIG. 15 shows a Products Pre-selection Menu.

The Products Pre-selection Menu is an open window to the product typology. With this menu, users may be able to establish specific preferences for the products they see in the shopping optimizer.

The Products Pre-selection Menu has the following sections:

Products Window 1502:

This window allows users to clearly visualize and compare the attributes of the existing market products within the product typology. Users can look at products from one or multiple supermarkets by activating/deactivating the buttons in the Supermarket Selection Bar located at the top of the screen 1506, based on that supermarket selection the Products Reel 1508 will present the relevant products to the user. The order of the products in the reel can be determined by the system based on relevance to the user (e.g. products similar to those already in the user pre-selection tab can be shown first). Users will be able to navigate through the Product Reel simply sliding from right to left, and using the Page Signal 510 on top of the Product Reel to understand their position within the reel. The reel will show all product details available in the shopping optimizer with no hidden items. Additionally the product illustration in this case will not be a zoom in image of the package logo, instead illustrations will show the entire package at scale. Finally products in the reel may all have one last indicator, the “Restriction Half-ball” 1512, this semicircle attached to the corner of each product in the reel, indicates the number of supermarkets from the users supermarket pool that distribute the specific product. Half-balls will have different colors depending on the degree of restriction the item implies.

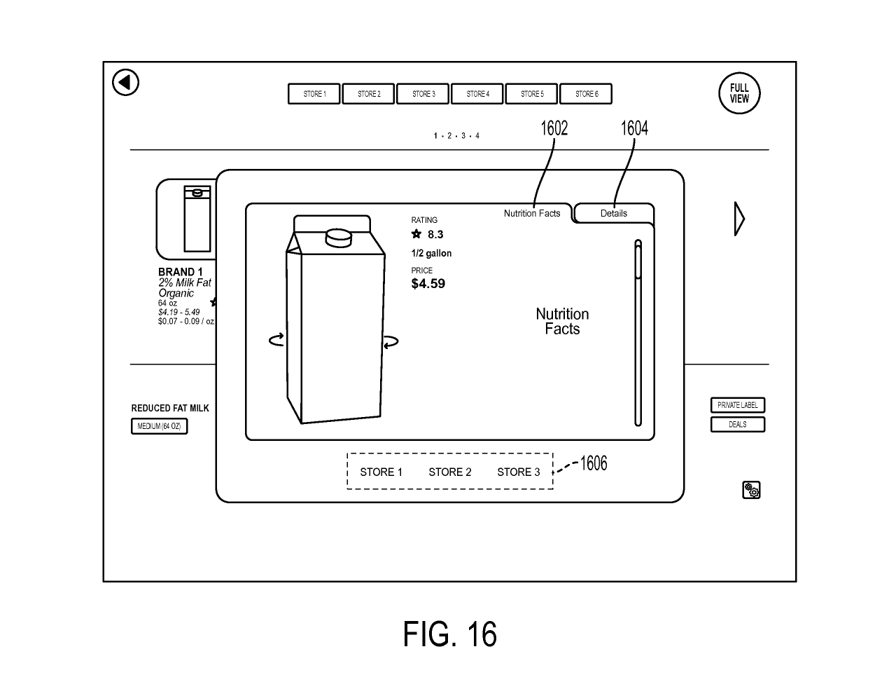

If a user wants to know more about any product in the Product Reel, he/she can get detailed info about it by double tapping on the product, this action will bring up an interface screen similar to that shown in FIG. 16, in which a larger image of the product is shown together with the product's nutritional facts 1602 and other details 1604. Finally in the bottom section of the pop-up 1606 the user can see the logos of the specific supermarkets in which the product is distributed.

The Pre-selection Tab 1504 can include a magnified version of the row in which the user did double tapping on the shopping optimizer. For example, the Pre-selection tab 1504, can permit the user to perform one or more of the following:

Pre-select 5 (e.g., the Common ones) of the 7 icons in the Products Menu for that typology 1514. To pre-select an icon, users can simply drag the product from the Product Reel into an empty icon on the Pre-selection Tab. Icons can be released from a pre-selection by just dragging the icon out of the Pre-selection tab. Empty icons 1516 can be filled up by the system with suggested products once the user goes back to the shopping optimizer. These suggested relevant products can be sourced based on the “Products Reel” ranking.

Trade one of the 5 common icons for the “Deals” special icon in that typology by activating the “Deals” button 1518.

Trade one of the 2 sponsored icons for a “Private Label” special icon in that typology. To do this, the user can activate the “Private Label” button 1520, and a sixth icon (Private Label) will appear in the pre-selection tab.

In addition, users can change the product format and preferences in the Pre-selection Tab by tapping on the Format 1522 and Gears 1524 buttons respectively.

In the system, there is a different Pre-selection Tab for every format. However, once a product is added to the Pre-selection Tab for a specific format, if the user modifies formats later on, the Products Reel will reflect the preference established in the earlier format. As such, even when the user changes formats to one who's Pre-selection Tab is empty, the shopping optimizer will suggest him/her the products already pre-selected for the earlier format as long as they are available in the new format, because it will consider them relevant to the user. For example, as shown in FIG. 15 the user pre-selected three milk products in the “Reduced Fat Milk typology—Medium Format”, if the user decides to change to the “Large Format” later on, he/she might have a completely empty Pre-selection Tab, however, those three products that he/she preselected for the Medium Format will show up in the first positions of the “Products Reel” as long as they are also available in the Large format, because the Products Reel makes suggestions based on relevance and if those three products were added in a different format it means they are relevant to the user. As a result, if the user does not make any pre-selections in the “Large Format” and goes back to the shopping optimizer, the 5 common icons will suggest the same products the user pre-selected for the medium format, as long as they are available in the large format (because they reflect the five first products of the Products Reel).

It may be important here to highlight the relationship between ratings and Pre-selection Tabs: product ratings in the system are objective (in contrast to common rating systems in some other sites which reflect the opinion of just one or a limited amount of users), the system ratings are based on the pre-selection that similar users do for that product typology. Products will be organized in each typology according to the following classification: superpremium, premium, standard and discounted. The rating of each product will then be determined based on how does that product compare with the other products in the same category. For example Premium products will compete with other premium products and ratings will be higher or lower depending on the number of users who include each product in their pre-selection tab. This will allow the system to get an objective metric of quality that was difficult or impossible prior to the present disclosure.

Finally, an important part of the Pre-selection Tab may be the Restriction Ball 1526, the number on the right half-ball represents the number of supermarkets the user can buy from with his pre-selection. The Restriction Ball will be explained in further detail down below but it can be a key element that may help some users understand the level of restriction added to his/her shopping optimization. To the right of the Restriction Ball in the Pre-selection Tab, the user will see the supermarkets 1528 in which according to the Restriction Ball he/she can or cannot buy with his/her pre-selection. If a supermarket cannot provide any of the products pre-selected it will show-up shaded as it is the case of “Pioneer” in the illustrated example.

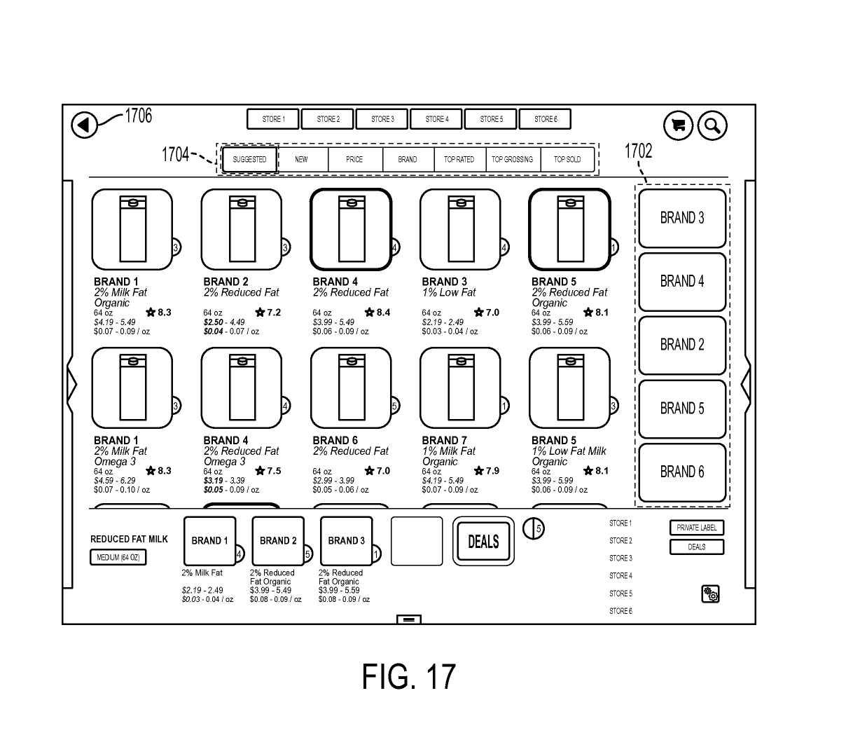

In summary, the Products Window shows those products that match the user preferences (regarding supermarket, product typology and product attributes) ranked according to the system suggesting engine criteria. However, some users might want to see the products ranked according to different criteria: by price, by brand, etc, for those users, the system provides the Products Pre-selection Matrix as shown in FIG. 17, which can be accessed by tapping on the Full View Button 1530.

The Products Pre-selection Matrix can include an advanced version of the Products Pre-selection Menu. Products are shown in a central scrollable image larger than the Product Reel. Unlike the Menu, the Matrix allows users to specify which brands they see products of as well as to rank the search results according to several criteria.

Activating/Deactivating Brands: Brand Logos are shown within a scrollable column 1702 on the side of the screen. Users can activate or deactivate the brands they want to see products of by simply tapping on the brand logos

Sorting Results: As mentioned above the Products Pre-selection Menu only shows products ranked in order of relevance based on the system algorithm. In the Matrix users can select their own criteria to sort results; they can do this thanks to the Sorting Bar 1704 located right above the central image. The bar is by default set on “suggested” as the sorting criterion but users can also use other criteria such as: New: sorts items by market launch date; Price: sorts items from cheap to expensive; Brand: sorts items alphabetically according to the brand they belong to; Top Rated: sorts items based on the product rating; Top Grossing: sorts items based on the Sales Growth %; and Top Sold: sorts items based on the total Sales (popularity). Other Matrix mechanics work similar to those of the Products Pre-selection Menu, including the Pre-selection Tab. Once the user has finished pre-selecting products for a row he/she can easily go back by taping on the “Go Back” button 1706.

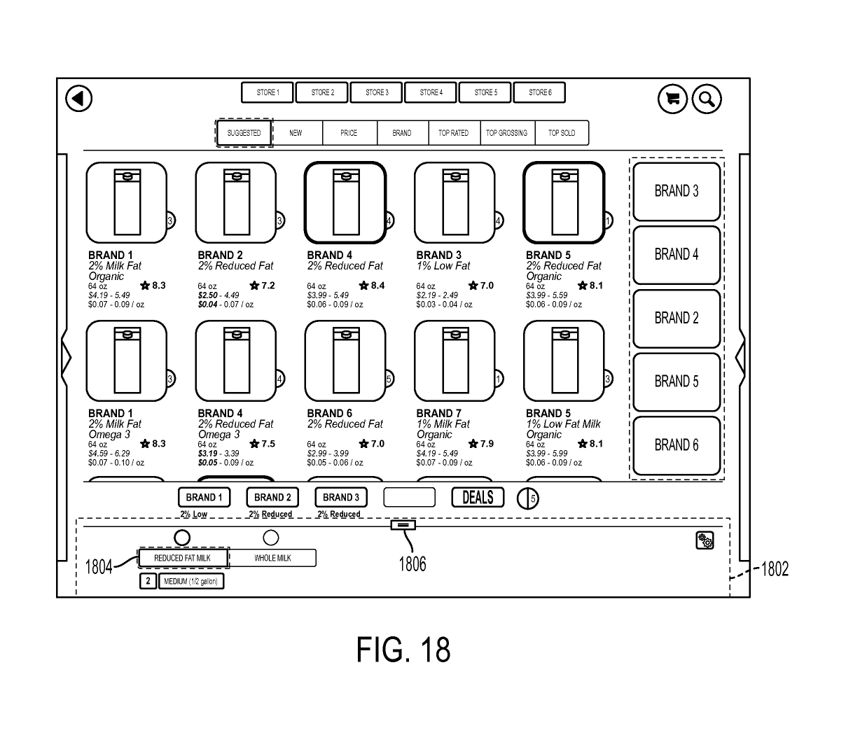

The Products Pre-selection Matrix can also be accessed from the Visual or Smart Shopping List Modes by just double tapping on any subcategory/typology illustration. In case of accessing from the Visual Shopping List, users can find a slightly modified version of the Matrix. This version allows them to set their preferences for any typology inside the product subcategory. For example, if a user double-taps on the “Milk” subcategory as shown in FIG. 8, the system can show the Milk Matrix shown in FIG. 18, this permits the user to directly set his/her Pre-selection Tab from the Visual Shopping List mode instead of doing it later on through the shopping optimizer. Unlike the Matrix shown in FIG. 17, which is restricted to the specific typology “Reduced Fat Milk”, the Matrix of FIG. 18 is restricted to a subcategory, in this case “Milk”. In order to make possible for users to add or change pre-selections for different typologies (e.g., reduced fat milk and whole milk), FIG. 18 has an overlaying tab in the bottom that allows the user to switch between the different typologies. This tab has a similar structure than that of the “Product Selection Area” 814, but in this case, product typologies are not just a title but also a button 1804, tapping on the typology buttons allow users to switch between the different typologies in the central image. This tab can be revealed or hidden by dragging up or down the expanding button 1806. The other functionalities of the Product Selection Area shown in FIG. 8 are also available in the tab: activating/deactivating typologies for the shopping list, changing units, formats and attributes and adding or removing typologies.

Sponsored icons 1314 can include icons sponsored by the product manufacturer and/or retailer. In one example implementation, there can be a maximum of two sponsored icons in every row and a minimum of one, as one can be traded for the “Private Label” special icon. Sponsored icons can be used to advertise the product but also to drive extremely targeted promotions. Sponsored icons can be easily identified by their blue background.

Special icons can represent not just one product but a group of products pre-selected by the user. There are two types of special icons:

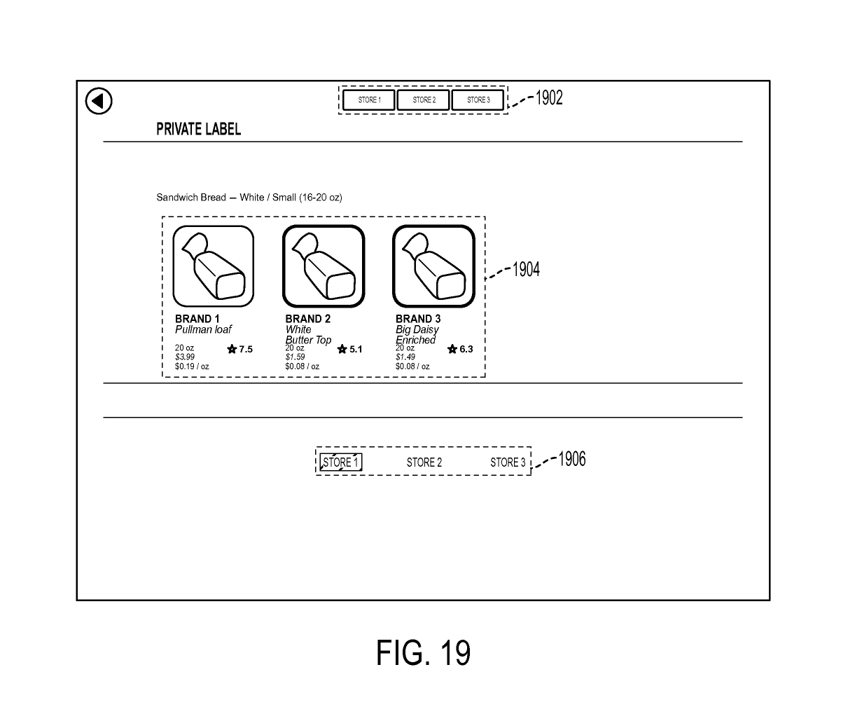

Private label icons 1336 provide a way for Private Label products to be sold through the system. Private label products may be very restrictive because every private label is distributed by just one retailer. To help ease this high level of restriction in the system, private label products can be grouped under the same icon, which can be activated by the user in the “Pre-selection Menu”. Double tapping in the Private Label icon will take the user to a screen similar to that shown in FIG. 19. The icon acts as a Pre-selection Tab itself but only for private label products, i.e. every product activated in FIG. 19, will be part of a Private Label pre-selection which will be taken into account by the system during the optimization phase (Step 4).

The private label icon pop-up includes the following elements:

The supermarket selection bar 1902 operates in a manner similar to the one in the Pre-selection Menu, i.e., it allows the user to select what supermarkets does he/she want to see products from. In the example illustrated in FIG. 19 the user activated supermarkets that have a private label for that product. Supermarkets with no private label for that product are not shown in the bar.

The products reel 1904 operates in a manner similar to the one in the Pre-selection Menu shown in FIG. 15, one difference is that in this case there is no Pre-selection Tab and products can be added or removed from the user selection by simply tapping into the product to activate/deactivate them. Products are activated when they have a yellow border around them. A Pre-selection tab could also be used in certain cases though if a product typology has many different attribute options.

The supermarket restriction portion 1906 of the Private Label icon pop-up shows which supermarkets the user is buying from with his/her selection of private label products. Supermarkets whose products have not been selected will be shown shaded as it is the case of Freshdirect shown in FIG. 19.

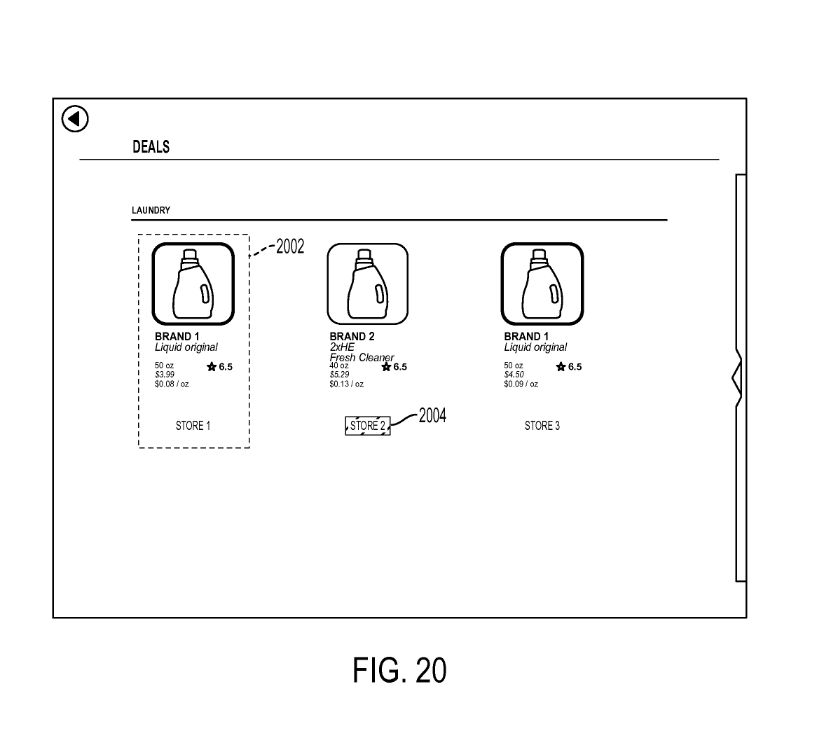

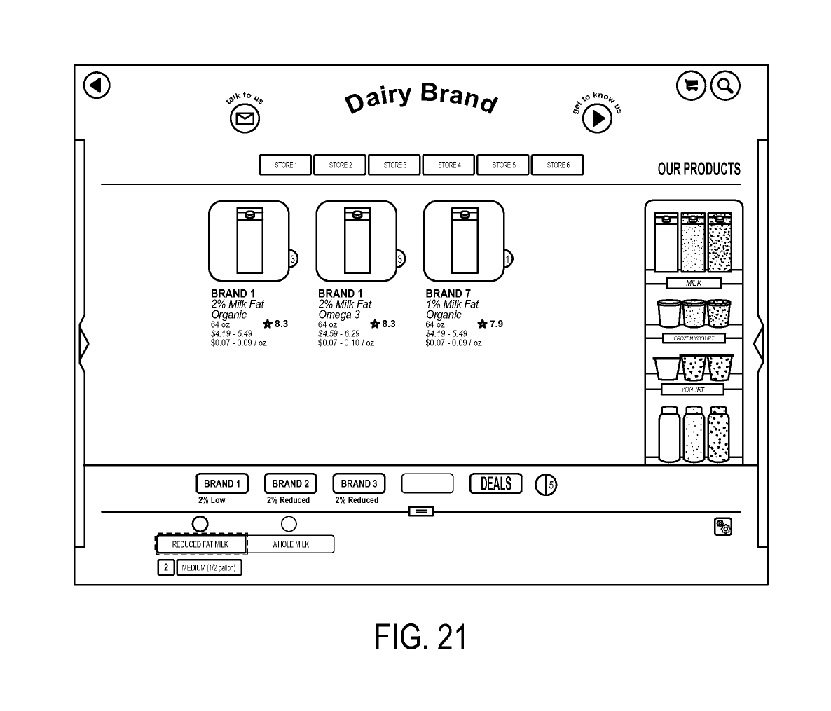

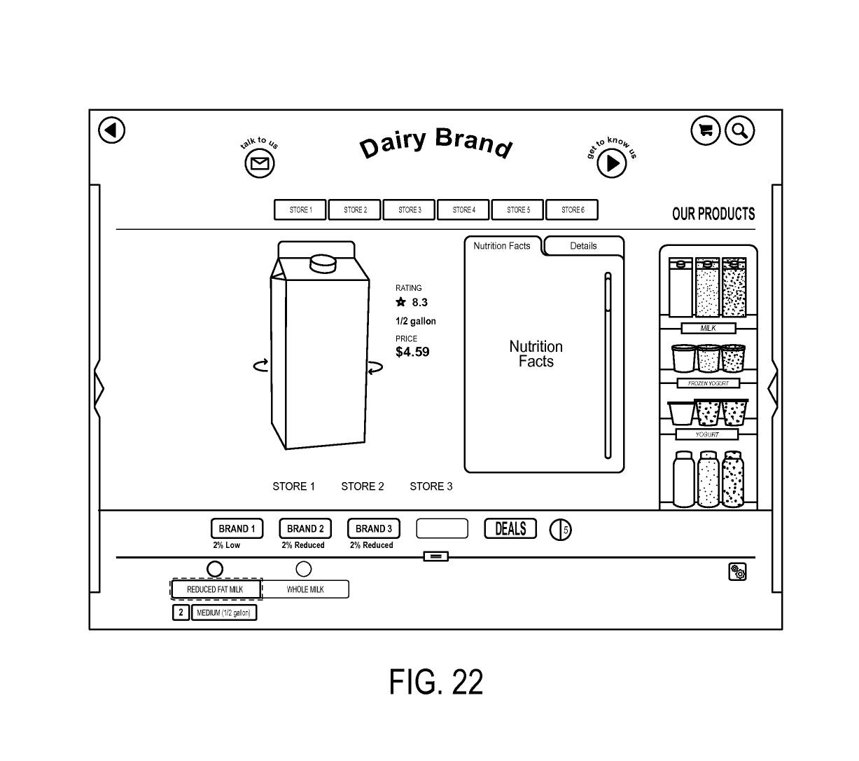

The deals icon 1338 can alert users to consider other products outside their pre-selected or usually consumed products when those other products are significantly discounted. Double tapping on the Deals icon will bring up a screen similar to that shown in FIG. 20, in which each supermarket will present the user with significantly discounted products that are not part of the user's pre-selection.

The Products Window 2002 is different than that shown in FIG. 15. Products here are not shown in a reel, instead each supermarket has its own column. In the illustrated example there are three supermarkets that have discounted promotions. Each supermarket showcases only one product at a time. Users can activate/deactivate the product for their selection by simply tapping into the product image. Once a product is tapped two side arrows “<” and “>” will pop up on the screen allowing the user to navigate through the different discounted promotions (if there is more than one) from that supermarket. Through this interface users can select a maximum of one product at a time from each supermarket. If the user does not select a product from a supermarket, its supermarket indicator 2004 will be shown shaded.

The restriction ball 1340 can be a key element of the Products Menu, it permits the user to understand the restriction implied by his/her products selection. The two Restriction Ball metrics impact heavily on where the user buys from and the value for money achieved during the shopping process:

The right half ball can represent the maximum number of supermarkets in which the user could buy the specific typology should he activate all 7 icons in the row. This number is heavily influenced by choices made in the Pre-selection Menu of FIG. 15. Restrictions made there can be monitored through the Restriction Half-ball 1524 located in the Pre-selection Tab.

The Right half-ball number in the Products Menu is independent, i.e. it does not reflect restrictions imposed by other typologies, e.g. if the products selection of other typology reduces potential supermarkets in that typology to just one, it will not affect the right half-ball number of all other typologies.

The left half-ball can represent the number of supermarkets in which the user is buying the specific typology with his current icon selection.

Section 4: Optimized Basket 1310

This section shows the user his/her optimal set of products: that is the set of products that while meeting the selection requirements established by the user in the system regarding shopping mode, products/brands and supermarkets, minimizes the total shopping expense (including delivery fees). Each item in the Optimized Basket is aligned with the typology that it represents. Items shown might not be the cheapest possible according to the price ranges in the row, but they are part of the cheapest basket in the market.

The Optimized Basket works closely with the “Purchase from” button 1306. If the user opts for purchasing from just one supermarket, the optimized basket can find the optimal combination of items based on one purchase. If the user considers purchasing from 2 supermarkets, the Optimized Basket can find the optimal combination of items based on one or two purchases whichever is best.

Each item in the Optimized basket can show one or more of: units, price per unit, discount (or coupon or volume promotion automatically applied), and supermarket in which that item is going to be purchased (this will be discussed below in connection with Step 4).

Section 5: Expense Summary Bar 1312

This section of the shopping optimizer shows the total cost of the Optimal Basket achieved by the system. The Expense Summary Bar shows: subtotal, fees (for collection (picking fee) or delivery (picking and delivery fees), taxes and total. If the user has selected to purchase only from one supermarket this information will just refer to that supermarket. If the user selected to purchase from several supermarkets, this information will be the sum of the different purchases. However, this section can reveal more detailed info by dragging up the expanding button 1412, this will reveal a tab containing the breakdown of costs by supermarket.

Navigation Buttons

In addition, there are three navigation buttons in the shopping optimizer:

The “Go to List” button 1414 can takes the user to a screen similar to that shown in FIG. 3.

The “Volume promotions” button 1416 can take the user to a screen similar to that shown in FIG. 12.

The “Check Out” button 1416 can permit the user to confirm his basket and check out once the user is happy with the basket selection and price. Other variables

Additionally another variable that can be included in the system optimization decision is time. For example there could be a button for selecting one or more of the following: time for the basket to be ready collection, and/or several delivery times. This button would act as a filter and the system would only optimize among the supermarkets who meet the criteria.

Step 4: Shopping optimization and user confirmation

Once users build their shopping list and brand selection. It is time to find out what is the best possible shopping for them. In general, to obtain the best results maximizing value for money, users should be as open as possible, i.e., the more options activated the bigger the number of supermarkets and possibilities analyzed by the system.

To optimize their shopping users can:

1) Select their preferred shopping mode: Self-shop, collect or delivery 1302

2) Select what supermarket they want to include in the optimization 1304

3) Review Units, Formats and Volume Promotions (e.g., line-by-line)

4) Activate/deactivate products to be added to the optimization (e.g., line-by-line):

There are two types of activation:

Simple Activation 1326:

To do this, users have to simply tap on the product icon. Icons are activated when they have a yellow border, and deactivated when they do not have it. When an icon is simply activated it means that it is counting towards the optimization within the product typology, i.e. if a basket is selected it can contain the product represented by that icon

Lock-Activation 1342

To do this, users have to keep the product icon tapped for 3 seconds. Icons are lock-activated when they have a red border. To deactivate them users only have to keep the icon tapped again for another 3 seconds.

When an icon is lock-activated it means that out of the number of units the user wants 1344, at least one has to be from the kind of product represented by the locked icon. In the illustrated example the user wants 3 Strawberry Yogurts but locked “1 unit of Stonyfield” and “1 unit of Dannon”. With this setting, the system will find an optimized basket with “1 unit of Stonyfield”, “1 unit of Dannon” and the third unit will be the 1 that out of the 5 icons left is part of the cheapest basket.

When an icon is locked a number in a red circle pops up on the upper right corner of the icon, this number determines how many units of that product the user is shopping. When tapping on the product icon a popup with “−/+” buttons shows up to allow users to modify units of the locked icon.

As a result of these product activations the Optimal Basket Section 1330 can continuously show the items fulfilling a user's (or multiple users′) restrictions belong to the cheapest possible basket in the market. To get to this basket, the system simply goes supermarket by supermarket calculating the cheapest basket in each supermarket and then compares them to show the basket with the minimum price out of all supermarkets. This can be done through standard linear optimization calculations. If the user is optimizing based on more than one transaction (which will be reviewed in more detail further down below), the system will use mathematical optimization formulae to get to the right transaction combination. Similar results can be obtained through existing products such as Excel Solver.

Disabled Icons/Buttons:

during the optimization process sometimes some conditions are mutually exclusive, for example if a product is only distributed by one supermarket and the user deactivates that supermarket in the Supermarket Selection Bar 1304 that product icon will be disabled (shown shaded) 1346 and will not be taken into account by. The system during the optimization process. This also happens with buttons, for example sometimes a combination of products cannot be provided by one specific supermarket, in this situation the supermarket's button will be disabled (shown shaded), e.g. Peapod 1420. Tapping on the disabled button will inform the user on alternatives to fix the problem.

Disabling activated product icons: if a product icon is activated (yellow border around it) and other conditions, such as deactivating a supermarket, disable the product icon, the product will still be shown although shaded 1346.

Disabling deactivated product icons: if a product icon is deactivated and suddenly another condition disables it, the system will react differently depending on whether that icon is pre-selected or suggested. If the icon is suggested, it will remove the disabled item and automatically show another product icon. If the icon is pre-selected it will still show the product icon although shaded 1348.

5) Select the number of transactions the user is willing to do in the “Purchase from” button 1306.

6) Review the Optimized Basket 1310 to make sure the user is satisfied with the supermarket, price and products optimized, if not modify buttons and icons accordingly to get to a satisfying solution.

Users will be able to find out what is the supermarket that sells the optimized basket by taking a look at the Supermarket Selection Bar. When the system finds out the optimized basket, the logo from that Supermarket shows a shining effect underneath. In the illustrations, this is the case of “Fairway” 1404.

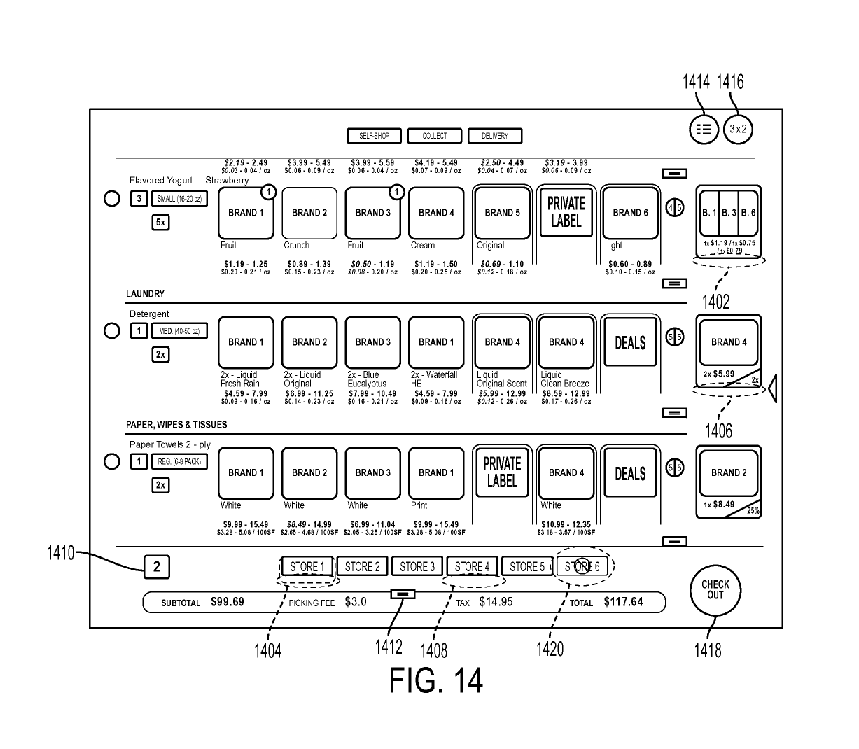

When the user selects other than “1” in the “Purchase from” button, items in the optimized basket will also show a shinning effect underneath 1402. Users will be able to identify what supermarket is providing each of the items by simply matching the shining colors. For example, as shown in FIG. 14, the user selected “2” in the “Purchase from” button 1410, meaning that this user is willing to split the purchase into two sets from two different supermarkets as long as it results in a greater value for him/her. The user can see at any point which supermarket is selling what by looking at the shining effect underneath the Optimized Basket icons and matching them with the shining effect underneath the Supermarket Selection Bar logos. In the example Fairway 1404 with a white shining underneath is selling the Yogurts 1402, while West Side Market 1408 is selling the Detergent 1406 and Paper Towels.

Once the user is satisfied with the optimized basket, tapping on the Check Out button 1418 will take them to the Check Out where they will be able to clearly review the basket items and confirm the purchase. The system can then process the payment based on the user's payment details stored in the system and send the order to the supermarket to be fulfilled.

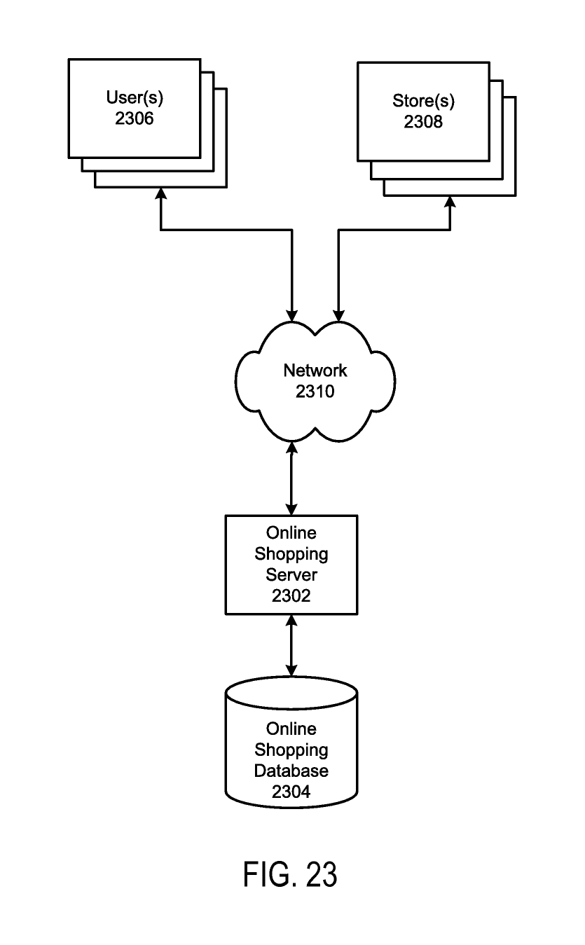

FIG. 23 is a diagram of an example online shopping system environment in accordance with at least one embodiment. The online shopping environment includes an online shopping server 2302 coupled to an online shopping database 2304. The server 2302 and database 2304 can be configured to provide the user interfaces discussed above and perform one or more steps of the method discussed below.

In operation, the online shopping server 2302 can connect with one or more stores 2308 via a network 2310 to obtain product availability and pricing information. One or more users 2306 can connect to the online shopping server 2302 via the network 2310 to perform online shopping optimization tasks as discussed herein.

The users can connect with a device such as a desktop computer, laptop computer, tablet device, wireless phone, media player, ebook reader or the like. The network 2310 can include a wired network, a wireless network, or a combination of the above.

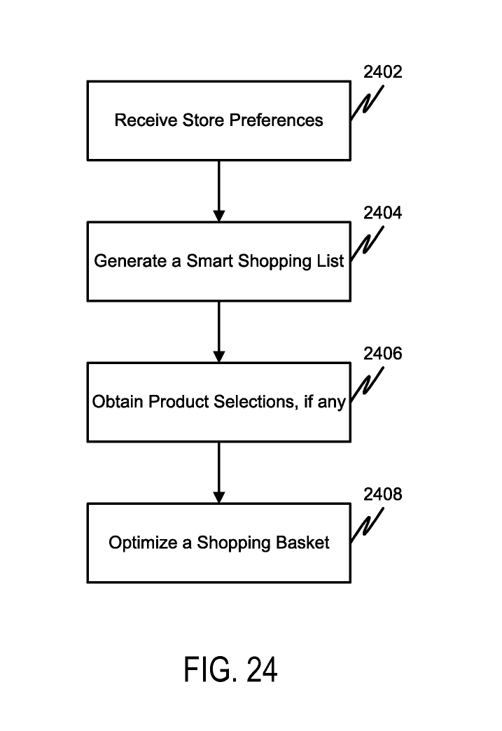

FIG. 24 is a flow chart of an example online shopping method in accordance with at least one embodiment. Processing begins at 2402, where store preferences are obtained. For example a system (e.g., 2302 or 2500) obtains store preferences from a user via a user interface (e.g., FIG. 1B and/or FIG. 2). Processing continues to 2404.

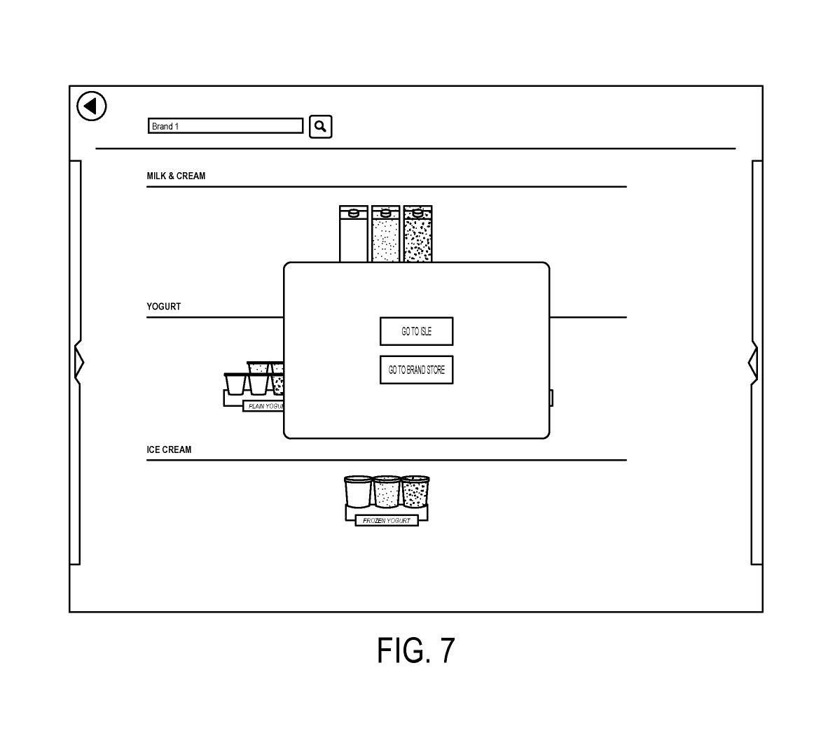

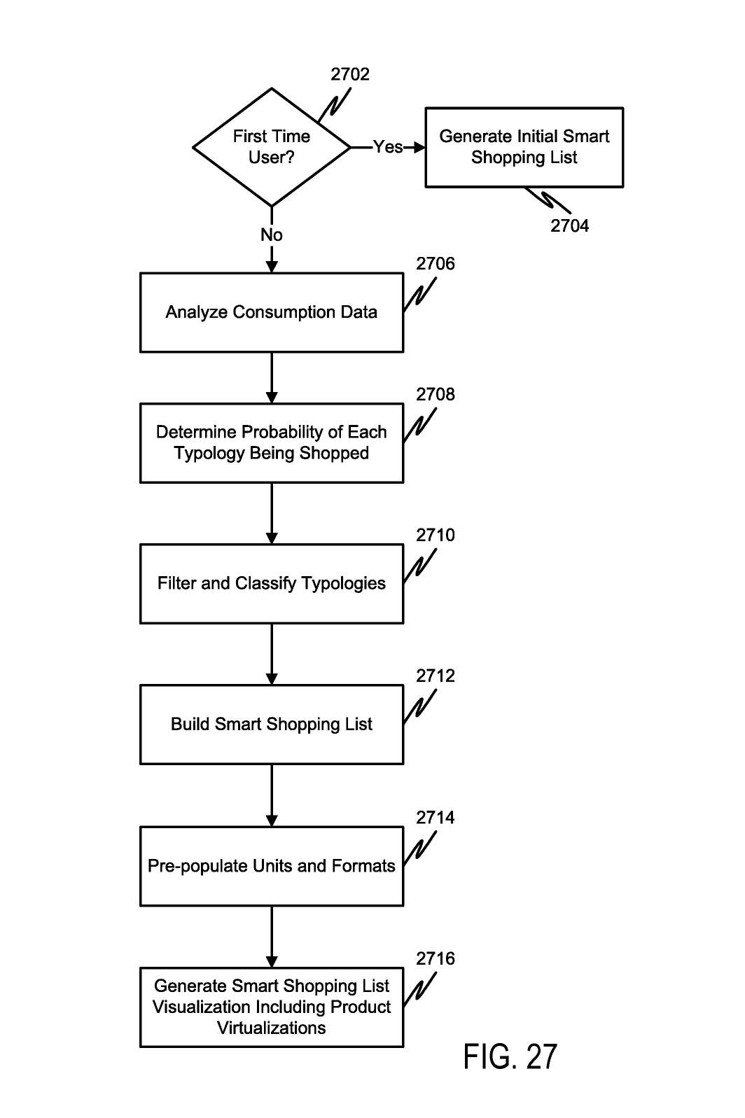

At 2404, a smart shopping list is generated. The smart shopping list can be generated based on a user's historical activity such as purchases and usage trends. A smart shopping list can also be generated based on one or more recipes. The smart shopping list can be automatically generated, manually generated or both. For example, the smart shopping list (e.g., FIGS. 3 and 4) can be generated by the system (e.g., 2302 or 2500); also product types can be added via the visual shopping list builder (e.g., FIGS. 4-10). Smart shopping list generation is shown in greater detail in FIG. 27, which is described below. Processing continues to 2406.

At 2406, product selections are obtained (e.g., FIGS. 13-20). Processing continues to 2408.

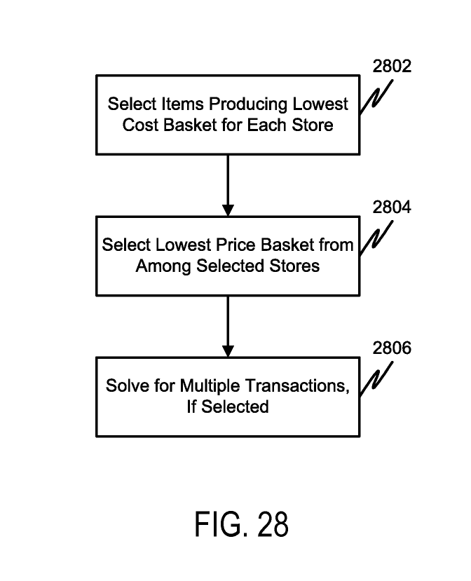

At 2408, an optimized shopping basket is generated (e.g., FIG. 13). Details of generating an optimized shopping basket are shown in FIG. 28 and described below.

It will be appreciated that 2402-2408 can be repeated in whole or in part in order to accomplish a contemplated online shopping task.

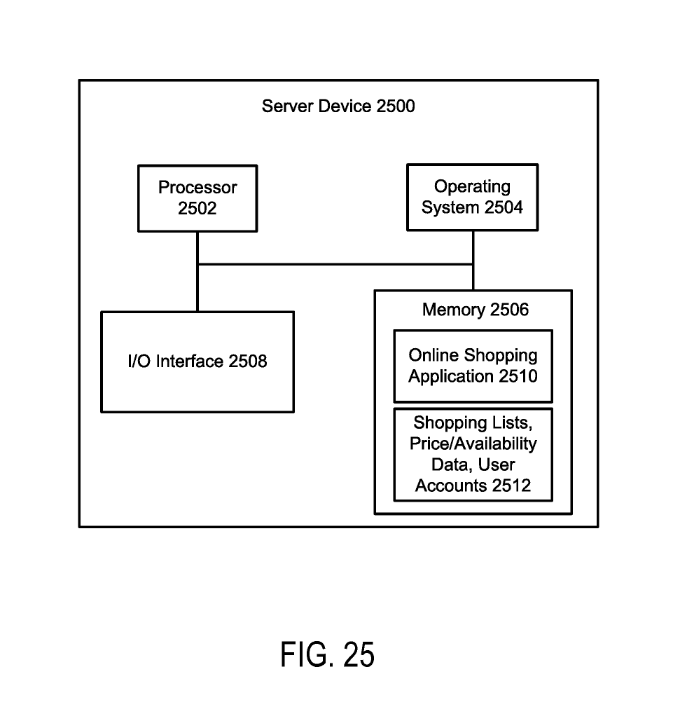

FIG. 25 is an example computer server system 2500 for online shopping in accordance with at least one embodiment. The server device 2500 includes a processor 2502, operating system 2504, memory 2506 and I/O interface 2508. The memory 2506 can include an online shopping application 2510 and a database of products, prices, details, shopping list and historical user data 2512.

In operation, the processor 2502 may execute the application 2512 stored in the memory 306. The application 2512 can include software instructions that, when executed by the processor, cause the processor to perform operations for online shopping in accordance with the present disclosure (e.g., performing one or more of steps 2402-2408 described above).

The application program 2512 can operate in conjunction with the stored of products, prices, details, shopping list and historical user data 2512 and the operating system 2504.

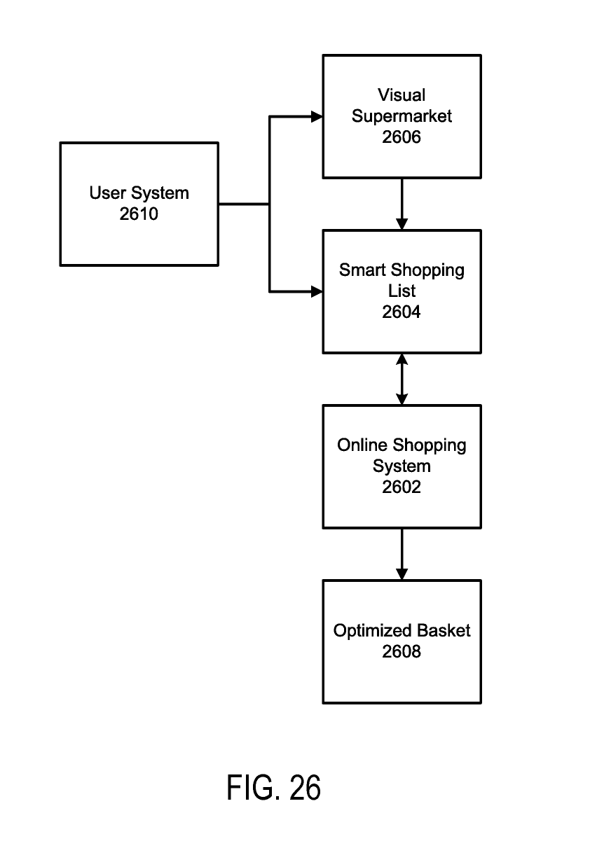

FIG. 26 is a diagram showing example online shopping data in accordance with at least one embodiment. An online shopping system 2602 is configured to generate a smart shopping list as discussed above. A user can interact with the smart shopping list 2604 via a user system 2610. The user can interact with the smart shopping list 2604 directly or via the visual supermarket 2606. Once the shopping list is finalized, the online shopping system 2602 can generate an optimized basket 2608.

It should be appreciated that the smart shopping list 2604 contains a list of product typologies (e.g., gallon of milk), not actual specific products (e.g., 1 gallon TG Lee Organic Whole Milk) The actual, specific products are listed in the optimized basket 2608 and are a result of the optimization process based on the store selection and shopping list in conjunction with any product selections.

FIG. 27 is a flow chart showing details of generating a smart shopping list 2404 in accordance with at least one embodiment. Processing begins at 2702, where the system determines if the user is a first time user. If so, processing continues to 2704. If the user is not a first time user, then processing continues to 2706.

At 2704, an initial smart shopping list is generated. The initial smart shopping list can generated manually by the user (e.g., by directly adding each element) or automatically by the system (e.g., based on the users' past consumption data extracted from retailers' loyalty card systems and/or based on the average consumption data from similar customers according to age, location, number of people in the family, pet ownership and the like).

At 2706, a smart shopping list is automatically generated for a returning user, which can include analyzing consumption data or patterns for product typologies. For example, the system can analyze consumption data for a given user establishing consumption cycles for one unit of each product typology (note the smart shopping list includes product typologies, not specific products). Processing continues to 2708.

At 2708, a probability of each typology being shopped during the current session is determined. Based on the consumption cycles, the system can determine a probability of a typology being shopped at that time. This calculation can take into account other variables including the estimated amount on inventory (based on previous purchases and/or shopping lists), average expiration dates in the typology and time passed from last consumption. Processing continues to 2710.

At 2710, the typologies are filtered and classified. For example, the system can filter each typology and classify that typology according to the probability of being shopped into one of a plurality of categories, such as highly likely, likely or uncertain. Typologies belonging to the highly likely tier will have a very high probability of being shopped (e.g., greater than about 85%) and will be shown activated in the list, those belonging to the likely tier will have a high probability (e.g., between about 70% and about 85%) and will be shown shaded and those belonging to the uncertain tier will have a lower probability (e.g., <about 70%) and will be hidden. Processing continues to 2712.

At 2712, a visual smart shopping list is built based on the classified typologies most likely to be shopped (e.g., the highly likely and the likely, with the highly likely being pre-selected to the smart shopping list). Processing continues to 2714.

At 2714, units and formats are pre-populated. For example, units and formats can be automatically selected based on average amount and format shopped by the user. Processing continues to 2716.

At 2716, a visualization is generated and caused to be displayed. For example, once the system has generated the automatic list, the system can create product virtualizations to represent items on the list. Items can be selected for product virtualizations based on relevance to the user, e.g. if the typology is Reduced Fat Milk and the user has selected only products with the attributes “Omega 3” that virtualization can include brands that produce this type of Reduced Fat Milk to generate the product virtualization.

FIG. 28 is a flow chart showing details of optimizing a shopping basket in accordance with at least one embodiment. Processing begins at 2802, where the system selects the items producing the lowest cost shopping basket for each supermarket. Processing continues to 2804.

At 2804, the minimum price basket of all of the supermarkets selected by the user is shown as the optimized basket. Processing continues to 2806.

At 2806, if the user has enabled more than one transaction, the system can use a mathematical optimization formula (e.g., similar to Excel Solver) to generate an optimal multi-transaction combination.

It will be appreciated that the modules, processes, systems, and sections described above can be implemented in hardware, hardware programmed by software, software instructions stored on a nontransitory computer readable medium or a combination of the above. A system as described above, for example, can include a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C, C++, C#.net, assembly or the like. The instructions can also comprise code and data objects provided in accordance with, for example, php, Ruby, the Visual Basic™ language, or another script, structured or object-oriented programming language. The sequence of programmed instructions, or programmable logic device configuration software, and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product (or software instructions stored on a nontransitory computer readable medium) may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the software engineering, publishing and electronic commerce arts.

Moreover, embodiments of the disclosed method, system, and computer readable media (or computer program product) can be implemented in software executed on a programmed general purpose computer, a special purpose computer, a microprocessor, or the like.

It is, therefore, apparent that there is provided, in accordance with the various embodiments disclosed herein, methods, systems and computer readable media for online shopping.

While the disclosed subject matter has been described in conjunction with a number of embodiments, it is evident that many alternatives, modifications and variations would be, or are, apparent to those of ordinary skill in the applicable arts. Accordingly, Applicant intends to embrace all such alternatives, modifications, equivalents and variations that are within the spirit and scope of the disclosed subject matter.

What is claimed is:

1. A computerized method comprising:
receiving, at one or more processors, an indication of one or more selected stores;
generating, at the one or more processors, a typologies shopping list in response to one or more of received data, historical data and user input;
receiving, at the one or more processors, product selections; and
generating, at the one or more processors, an optimized shopping basket based on the selected stores, the typologies shopping list and the product selections.

2. The method of claim 1, wherein the generating an optimized shopping basket comprises:
determining, at the one or more processors, a shopping mode selection;
identifying, at the one or more processors, one or more stores having an activated status;
translating, at the one or more processors, the typologies shopping list into specific items based on activated typologies and product attribute selections;
providing, with the one or more processors, the shopping mode selection, the product selection, the optimized shopping basket and an expense summary bar for display to a user on a single user interface screen.

3. The method of claim 1, wherein receiving product selections includes:
causing to be displayed a user interface having a multi-layered horizontal scrolling element configured to provide store navigation without displaying drop-down menus; and
receiving one or more product selections from the multi-layered horizontal scrolling element.

4. The method of claim 1, wherein generating the typologies shopping list includes generating a typologies shopping list in response to one or more of received data, historical data and user input from a plurality of users,
wherein the receiving, at the one or more processors, product selections includes receiving product selections from the plurality of users, and
wherein generating, at the one or more processors, includes generating an optimized shopping basket including the product selections of the plurality of users.

5. The method of claim 1, further comprising providing one or more suggested products based on consumption patterns of one or more of a user associated with the typologies shopping list or one or more users not associated with the typologies shopping list of the user.

6. A system comprising a processor coupled to a data storage device having stored therein software instructions that, when executed by the processor, cause the processor to perform operations including:
receiving an indication of one or more selected stores;
generating a typologies shopping list in response to one or more of received data, historical data and user input;
receiving product selections; and
generating an optimized shopping basket based on the selected stores, the typologies shopping list and the product selections.

7. The system of claim 6, wherein the generating an optimized shopping basket further includes:
determining a shopping mode selection;
identifying one or more stores having an activated status;
translating the typologies shopping list into specific items based on activated typologies and product attribute selections;
providing the shopping mode selection, the product selection, the optimized shopping basket and an expense summary bar for display to a user on a single user interface screen.

8. The system of claim 6, wherein receiving product selections includes:
causing to be displayed a user interface having a multi-layered horizontal scrolling element configured to provide store navigation without displaying drop-down menus; and
receiving one or more product selections from the multi-layered horizontal scrolling element.

9. The system of claim 6, wherein the operations further comprise displaying quality ratings for one or more products, wherein each quality rating is based on actual user pre-selection data.

10. The system of claim 6, wherein the operations further comprise providing one or more suggested products based on consumption patterns of one or more of a user associated with the typologies shopping list or one or more users not associated with the typologies shopping list of the user.

11. A nontransitory computer readable medium having stored thereon software instructions that, when executed by a processor, cause the processor to perform operations including:
receiving an indication of one or more selected stores;
generating a typologies shopping list in response to one or more of received data, historical data and user input;
receiving product selections; and
generating an optimized shopping basket based on the selected stores, the typologies shopping list and the product selections.

12. The nontransitory computer readable medium of claim 11, wherein the generating an optimized shopping basket further includes:
determining a shopping mode selection;
identifying one or more stores having an activated status;
translating the typologies shopping list into specific items based on activated typologies and product attribute selections;
providing the product selection, the optimized shopping basket and an expense summary bar for display to a user on a single user interface screen.

13. The nontransitory computer readable medium of claim 11, wherein receiving product selections includes:
causing to be displayed a user interface having a multi-layered horizontal scrolling element configured to provide store navigation without displaying drop-down menus; and
receiving one or more product selections from the multi-layered horizontal scrolling element.

14. The nontransitory computer readable medium of claim 11, wherein receiving product selections includes causing a typologies based search interface to be displayed, searching typologies based on one or more user entered search terms, and displaying one or more typology results.

15. The nontransitory computer readable medium of claim 11, wherein the operations further comprise providing one or more suggested products based on consumption patterns of one or more of a user associated with the typologies shopping list or one or more users not associated with the typologies shopping list of the user.

16. The method of claim 1, wherein the typologies shopping list includes an identification of one or more product typologies.

17. The system of claim 6, wherein the typologies shopping list includes an identification of one or more product typologies.

18. The nontransitory computer readable medium of claim 11, wherein the typologies shopping list includes an identification of one or more product typologies.

19. The method of claim 1, wherein each typology includes a product type and does not include a specific stocked item to be purchased.

20. The system of claim 6, wherein each typology includes a product type and does not include a specific stocked item to be purchased.
